(19) United States
(12) Patent Application Publication
(10) Pub. No.: US 2014/0321392 A1
(43) Pub. Date: Oct. 30, 2014

(54) METHOD FOR DETERMINING UPLINK TRANSMISSION POWER AND USER EQUIPMENT

(71) Applicant: Huawei Technologies Co., Ltd., Shenzhen (CN)

(72) Inventor: Yuanjie Li, Shenzhen (CN)

(21) Appl. No.: 14/325,001

(22) Filed: Jul. 7, 2014

Related U.S. Application Data
(63) Continuation of application No. PCT/CN2012/087885, filed on Dec. 28, 2012.

(30) Foreign Application Priority Data
Jan. 9, 2012 (CN) 201210004601.0

(51) Int. Cl. H04W 52/14; H04W 72/02

(52) U.S. Cl. CPC H04W 52/146; H04W 72/02
USPC 370/329

(57) ABSTRACT

The present invention provides a method for determining an uplink transmission power and a user equipment. In the present invention, a user equipment determines an overlap between an uplink channel of a cell in a current subframe and an uplink channel of another cell in an adjacent subframe, the cell being carrier aggregation with the another cell, so that the user equipment can determine transmission power of a PUSCH of the cell in the current subframe and the another cell in the current subframe, the another cell being carrier aggregation with the cell. As a result, the problem that the uplink power control performed by the user equipment according to the prior art is not accurate is solved and thus the uplink data transmitting quality is improved.

### CROSS-REFERENCE TO RELATED APPLICATIONS

This application is a continuation of International Application No. PCT/CN2012/087885, filed on Dec. 28, 2012, which claims priority to Chinese Patent Application No. 201210004601.0, filed on Jan. 9, 2012, both of which are incorporated herein by reference in their entireties.

### TECHNICAL FIELD

The present invention relates to communication technologies and, in particular, to a method for determining an uplink transmission power and a user equipment.

### BACKGROUND

In a wireless communication system with the carrier aggregation (Carrier Aggregation, CA for short) feature, a user equipment may communicate with a base station through multiple cells. During uplink transmission, to ensure that uplink signals of all user equipments belonging to a base station arrive at the base station synchronously, the base station may adjust the time of transmitting uplink signals by the user equipment, that is, uplink transmit time, according to the offset condition of the arriving time of uplink signals of user equipments.

However, because uplink signals of user equipments may be transmit to the base station through different cells along different paths, for example, uplink signals transmitted by the user equipment to the base station may need to pass through a relay node when the uplink signals are transmitted through some cells, but may not need to pass through a relay node when the uplink signals are transmitted through some another cells, therefore, the uplink transmit time of user equipments may be different. As a result, the uplink power control performed by the UE based on the prior art is not accurate, thereby degrading the uplink data transmitting quality.

### SUMMARY

The present invention provides a method for determining an uplink transmission power and a user equipment, so as to improve the uplink data transmitting quality.

In one aspect, a method for determining an uplink transmission power is provided and includes:

determining, by a user equipment, an overlap between an uplink channel of a cell in a current subframe and an uplink channel of the another cell which processes carrier aggregation with the cell in an adjacent subframe; and

determining, by the user equipment according to the determined overlap, transmission power of a physical uplink shared channel (PUSCH) of the cell in the current subframe and the another cell which processes carrier aggregation with the cell in the current subframe.

In another aspect, a user equipment is provided and includes:

an overlap determining unit, configured to determine an overlap between an uplink channel of a cell in a current subframe and an uplink channel of the another cell which processes carrier aggregation with the cell in an adjacent subframe; and

a power determining unit, configured to determine, according to the overlap determined by the overlap determining unit, transmission power of a physical uplink shared channel (PUSCH) of the cell in the current subframe and the another cell which processes carrier aggregation with the cell in the current subframe.

It may be known from the above technical solution that, in embodiments of the present invention, the user equipment determines an overlap between an uplink channel of a cell in a current subframe and an uplink channel of the another cell which processes carrier aggregation with the cell in an adjacent subframe, so that the user equipment can determine transmission power of a PUSCH of the cell in the current subframe and the another cell which processes carrier aggregation with the cell in the current subframe. As a result, the problem that the uplink power control performed by the user equipment according to the prior art is not accurate is solved and thus the uplink data transmitting quality is improved.

### BRIEF DESCRIPTION OF DRAWINGS

To illustrate the technical solutions in embodiments of the present invention or in the prior art more clearly, the following briefly introduces the accompanying drawings required for describing the embodiments or the prior art. Apparently, the accompanying drawings in the following description show some embodiments of the present invention, and persons of ordinary skill in the art may still derive other drawings from these accompanying drawings without creative efforts.

FIG. 1 is a schematic flowchart of a method for determining an uplink transmission power according to an embodiment of the present invention; and

FIG. 2 is a schematic structural diagram of a user equipment according to another embodiment of the present invention.

### DESCRIPTION OF EMBODIMENTS

To make the objectives, technical solutions, and advantages of embodiments of the present invention more comprehensible, the following clearly and completely describes the technical solutions in embodiments of the present invention with reference to the accompanying drawings in embodiments of the present invention. Apparently, the described embodiments are merely a part rather than all of the embodiments of the present invention. All other embodiments obtained by a person of ordinary skill in the art based on embodiments of the present invention without creative efforts shall fall within the protection scope of the present invention.

The technical solution of the present invention can be applied to various wireless communication systems such as a Global System for Mobile Communications (Global System for Mobile Communications, GSM for short), a General Packet Radio Service (General Packet Radio Service, GPRS for short) network, a Code Division Multiple Access (Code Division Multiple Access, CDMA for short) network, a Wideband Code Division Multiple Access (Wideband Code Division Multiple Access, WCDMA for short) network, a Time Division-Synchronous Code Division Multiple Access (Time Division-Synchronous Code Division Multiple Access, TD-SCDMA for short) network, a Long Term Evolution (Long Term Evolution, LTE for short) or a Long Term Evolution Advanced (LTE Advanced, LTE-A for short) network and subsequent evolution networks. The terms “network” and “system” are interchangeable.

The cells involved in embodiments of the present invention may also be understood as carriers, where the concept of the cells and the carriers are the same.

The subframe parameters t, t1, or t2 involved in embodiments of the present invention may be ii (representing the subframe previous to the current subframe) or i+1 (representing the subframe following the current subframe), which is not limited herein.

The power involved in embodiments of the present invention is linear power.

The channel overlap involved in embodiments of the present invention can be understood as a subframe overlap (that is, the current subframe and an adjacent subframe are partially overlapped in time) between uplink signals transmitted by the user equipment through different cells.

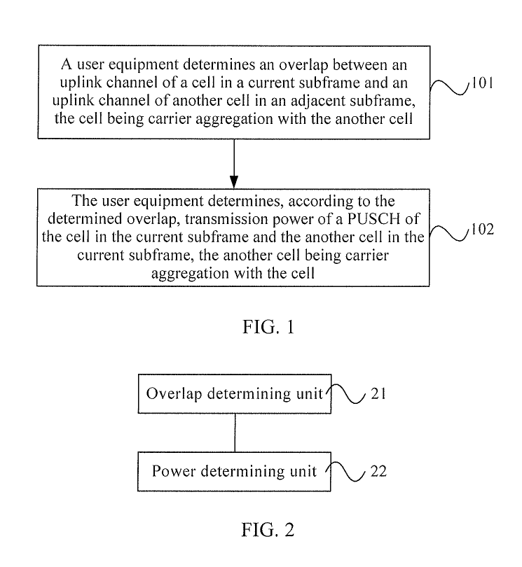

FIG. 1 is a schematic flowchart of a method for determining an uplink transmission power according to an embodiment of the present invention. As shown in FIG. 1, the method for determining an uplink transmission power in this embodiment may include the following:

101: A user equipment determines an overlap between an uplink channel of a cell in a current subframe and an uplink channel of another cell in an adjacent subframe, the cell being carrier aggregation with the another cell.

In this embodiment, the user equipment may determine the overlap between the uplink channels in one of the following ways:

For example, the user equipment determines the overlap according to the uplink transmit time of the cell and that of the other cells which processes carrier aggregation with the cell. If the uplink transmit time of different cells is different, the uplink channels will overlap with each other.

In another example, the user equipment determines whether the cells which processes carrier aggregation belong to different TA (time advance, time advance) groups. If the cells belong to different TA groups, the uplink channels of different TA groups will overlap with each other.

In still another example, the user equipment determines whether the TA value adjustment of the cells which processes carrier aggregation in the uplink are the same. If the TA value adjustments are different, the uplink channels of the cells with different TA value adjustments will overlap with each other.

Persons skilled in the art may understand that the user equipment can also determine the overlap between uplink channels in other ways, which are not limited in the present invention.

102: The user equipment determines, according to the determined overlap, transmission power of a physical uplink shared channel (PUSCH) of the cell in the current subframe and the another cell in the current subframe, the another cell being carrier aggregation with the cell. According to an optional implementation mode provided in embodiments of the present invention, in 101, the overlap determined by the user equipment may include: the PUSCH of the cell in the current subframe is overlapped with the PUCCH of the another cell in the adjacent subframe, the another cell being carrier aggregation with the cell.

For example, in 102, the user equipment determines, according to formula (1), first transmission power of the PUSCH of the cell in the current subframe and the another cell which processes carrier aggregation with the cell in the current subframe, where:

$${\sum }_{c} w ( i ) \cdot {P}_{PUSCH , c} ( i ) \leq ( {P}_{CMAX} ( i ) - max ( {P}_{PUCCH} ( i ) , {P}_{PUCCH} ( t ) ) ) \qquad ( 1 )$$

where w(i) represents a weighting factor, whose value range is [0, 1]; c represents a cell;

$${\sum }_{c} w ( i ) \cdot {P}_{PUSCH , c} ( i )$$

represents the first transmission power of the PUSCH of the cell in the current subframe and the another cell which processes carrier aggregation with the cell in the current subframe; P_{PUCCH}(i) represents first transmission power, which is obtained by the user equipment by performing uplink power control, of a PUCCH of the another cell which processes carrier aggregation with the cell in the current subframe; P_{PUCCH}(t) represents first transmission power, which is obtained by the user equipment by performing uplink power control, of the PUCCH of the another cell which processes carrier aggregation with the cell in the adjacent subframe; and P_{CMAX}(i) represents maximum allowable power of the current subframe.

For example, the PUSCH of the cell in the current subframe and the another cell which processes carrier aggregation with the cell in the current subframe includes a PUSCH bearing uplink signaling.

In 102, the user equipment may specifically determine, according to formulas (2) and (3), second transmission power of the PUSCH of the cell in the current subframe and the another cell which processes carrier aggregation with the cell in the current subframe, where:

$$\begin{matrix}{\sum }_{c \neq j} w ( i ) \cdot {P}_{PUSCH , c} ( i ) \leq ( {P}_{CMAX} ( i ) - {P}_{PUSCH , j} ( i ) - {P}_{PUCCH} ( t ) ) & ( 2 ) \\ {P}_{PUSCH , j} ( i ) = min \{ {P}_{PUSCH , j \_ o} ( i ) , ( {P}_{CMAX} ( i ) - {P}_{PUCCH} ( t ) ) \} & ( 3 )\end{matrix}$$

where w(i) represents a weighting factor, whose value range is [0, 1]; c represents a cell;

$${\sum }_{c \neq j} w ( i ) \cdot {P}_{PUSCH , c} ( i )$$

represents second transmission power of a PUSCH bearing no uplink control signaling of the cell in the current subframe, and the another cell which processes carrier aggregation with the cell in the current subframe; P_{PUCCH}(t) represents second transmission power, which is obtained by the user equipment by performing uplink power control, of the PUCCH of the another cell which processes carrier aggregation with the cell in the adjacent subframe; P_{CMAX}(i) represents maximum allowable power of the current subframe; and P_{PUSCH,j}_{_{—}}ₒ(i) represents first transmission power, which is obtained by the user equipment by performing uplink power control, of a PUSCH bearing uplink signaling included in the current subframe.

In 102, the user equipment may also specifically determine, according to formula (4), third transmission power of the PUSCH of the cell in the current subframe and the another cell which processes carrier aggregation with the cell in the current subframe, where:

$${\sum }_{c \neq j} w ( i ) \cdot {P}_{PUSCH , c} ( i ) + u ( i ) \cdot {P}_{PUSCH , j} ( i ) \leq ( {P}_{CMAX} ( i ) - {P}_{PUCCH} ( t ) ) \qquad ( 4 )$$

where w(i) and u(i) represent weighting factors, whose value range is [0, 1]; c represents a cell;

$${\sum }_{c \neq j} w ( i ) \cdot {P}_{PUSCH , c} ( i )$$

represents third transmission power of a PUSCH bearing no uplink control signaling of the cell in the current subframe and the another cell which processes carrier aggregation with the cell in the current subframe; P_{PUCCH}(i) represents third transmission power, which is obtained by the user equipment by performing uplink power control, of the PUCCH of the another cell which processes carrier aggregation with the cell in the adjacent subframe; P_{CMAX}(i) represents maximum allowable power of the current subframe; and P_{PUSCH,j}(i) represents first transmission power, which is obtained by the user equipment by performing uplink power control, of a PUSCH bearing uplink control signaling in the current subframe.

For example, the PUSCH of the cell in the current subframe and the another cell which processes carrier aggregation with the cell in the current subframe includes a PUSCH that bears uplink control signaling, and a PUCCH is further included in the cell in the current subframe and the another cell which processes carrier aggregation with the cell in the current subframe.

In 102, the user equipment may also specifically determine, according to formulas (5) and (6), fourth transmission power of the PUSCH of the cell in the current subframe and the another cell which processes carrier aggregation with the cell in the current subframe, where:

$$\begin{matrix}{\sum }_{c \neq j} w ( i ) \cdot {P}_{PUSCH , c} ( i ) \leq ( {P}_{CMAX} ( i ) - {P}_{PUSCH , j} ( i ) - max ( {P}_{PUCCH} ( i ) , {P}_{PUCCH} ( t ) ) ) & ( 5 ) \\ {P}_{PUSCH , j} ( i ) = min \{ {P}_{PUSCH , j \_ o} ( i ) , ( {P}_{CMAX} ( i ) - max ( {P}_{PUCCH} ( i ) , {P}_{PUCCH} ( t ) ) ) \} & ( 6 )\end{matrix}$$

where w(i) represents a weighting factor, whose value range is [0, 1]; c represents a cell;

$${\sum }_{c \neq j} w ( i ) \cdot {P}_{PUSCH , c} ( i )$$

represents fourth transmission power of a PUSCH bearing no uplink control signaling of the cell in the current subframe and the another cell which processes carrier aggregation with the cell in the current subframe; P_{PUCCH}(i) represents second transmission power, which is obtained by the user equipment by performing uplink power control, of the PUCCH of the another cell which processes carrier aggregation with the cell in the current subframe; P_{PUCCH}(t) represents fourth transmission power, which is obtained by the user equipment by performing uplink power control, of the PUCCH of the another cell which processes carrier aggregation with the cell in the adjacent subframe; P_{CMAX}(i) represents maximum allowable power of the current subframe; and P_{PUSCH,j}_{_{—}}ₒ(i) represents second transmission power, which is obtained by the user equipment by performing uplink power control, of the PUSCH bearing uplink signaling included in the current frame.

In 102, the user equipment may also specifically determine, according to formula (7), fifth transmission power of the PUSCH of the cell in the current subframe and the another cell which processes carrier aggregation with the cell in the current subframe, where:

$${\sum }_{c \neq j} w ( i ) \cdot {P}_{PUSCH , c} ( i ) + u ( i ) \cdot {P}_{PUSCH , j} ( i ) \leq ( {P}_{CMAX} ( i ) - max ( {P}_{PUCCH} ( i ) , {P}_{PUCCH} ( t ) ) ) \qquad ( 7 )$$

where w(i) and u(i) represent weighting factors, whose value range is [0, 1]; c represents a cell;

$${\sum }_{c \neq j} w ( i ) \cdot {P}_{PUSCH , c} ( i )$$

represents fifth transmission power of a PUSCH bearing no uplink control signaling of the cell in the current subframe and the another cell which processes carrier aggregation with the cell in the current subframe; P_{PUCCH}(i) represents third transmission power, which is obtained by the user equipment by performing uplink power control, of the PUCCH of the another cell which processes carrier aggregation with the cell in the current subframe; P_{PUCCH}(t) represents fifth transmission power, which is obtained by the user equipment by performing uplink power control, of the PUCCH of the another cell which processes carrier aggregation with the cell in the adjacent subframe; P_{CMAX}(i) represents maximum allowable power of the current subframe; and P_{PUSCH,j}(i) represents second transmission power, which is obtained by the user equipment by performing uplink power control, of a PUSCH bearing uplink control signaling in the current subframe.

According to another optional implementation mode provided in embodiments of the present invention, in 101, the overlap determined by the user equipment may further include: the PUSCH of the cell in the current subframe, or a PUCCH of the cell in the current subframe, or at least one of the PUSCH and the PUCCH of the cell in the current subframe is overlapped with a PUSCH bearing uplink signaling in the another cell in the adjacent subframe, the another cell being carrier aggregation with the cell.

For example, in 102, the user equipment determines, according to formula (8), sixth transmission power of the PUSCH of the cell in the current subframe and the another cell which processes carrier aggregation with the cell in the current subframe, where:

$${\sum }_{c} w ( i ) \cdot {P}_{PUSCH , c} ( i ) \leq ( {P}_{CMAX} ( i ) - {P}_{PUSCH , k} ( t ) - {P}_{PUCCH} ( i ) ) \qquad ( 8 )$$

where w(i) represents a weighting factor, whose value range is [0, 1]; c represents a cell;

$${\sum }_{c} w ( i ) \cdot {P}_{PUSCH , c} ( i )$$

represents the sixth transmission power of the PUSCH of the cell in the current subframe and the another cell which processes carrier aggregation with the cell in the current subframe; P_{PUCCH}(i) represents fourth transmission power, which is obtained by the user equipment by performing uplink power control, of the PUCCH of the cell or the another cell which processes carrier aggregation with the cell in the current subframe; P_{CMAX}(i) represents maximum allowable power of the current subframe; and P_{PUSCH,k}(t) represents first transmission power, which is obtained by the user equipment by performing uplink power control, of the PUSCH bearing uplink control signaling of the cell in the adjacent subframe and the another cell which processes carrier aggregation with the cell in the adjacent subframe.

In 102, the user equipment may also specifically determine, according to formula (9), seventh transmission power of the PUSCH of the cell in the current subframe and the another cell which processes carrier aggregation with the cell in the current subframe, where:

$${\sum }_{c} w ( i ) \cdot {P}_{PUSCH , c} ( i ) + u ( i ) \cdot {P}_{PUSCH , k} ( t ) + v ( i ) \cdot {P}_{PUCCH} ( i ) \leq {P}_{CMAX} ( i ) \qquad ( 9 )$$

where w(i), u(i), and v(i) represent weighting factors, whose value range is [0, 1]; c represents a cell;

$${\sum }_{c} w ( i ) \cdot {P}_{PUSCH , c} ( i )$$

represents the seventh transmission power of the PUSCH of the cell in the current subframe and the another cell which processes carrier aggregation with the cell in the current subframe; P_{PUCCH}(i) represents fifth transmission power, which is obtained by the user equipment by performing uplink power control, of the PUCCH of the cell or the another cell which processes carrier aggregation with the cell in the current subframe; P_{CMAX}(i) represents maximum allowable power of the current subframe; and P_{PUSCH,k}(t) represents second transmission power, which is obtained by the user equipment by performing uplink power control, of a PUSCH bearing uplink signaling of the cell in the adjacent subframe and the another cell which processes carrier aggregation with the cell in the adjacent subframe.

For example, the PUSCH of the cell in the current subframe and the another cell which processes carrier aggregation with the cell in the current subframe includes a PUSCH bearing uplink signaling.

In 102, the user equipment may also specifically determine, according to formulas (10) and (11) or formulas (10) and (12), eighth transmission power of the PUSCH of the cell in the current subframe and the another cell which processes carrier aggregation with the cell in the current subframe, where:

$$\begin{matrix}{\sum }_{c \neq j} w ( i ) \cdot {P}_{PUSCH , c} ( i ) \leq ( {P}_{CMAX} ( i ) - {P}_{PUSCH , j} ( i ) - {P}_{PUSCH , k} ( t ) ) & ( 10 ) \\ {P}_{PUSCH , j} ( i ) = min \{ {P}_{PUSCH , j\_o} ( i ) , ( {P}_{CMAX} ( i ) - {P}_{PUSCH , k\_o} ( i - 1 ) ) \} & ( 11 ) \\ {P}_{PUSCH , j} ( i ) = min \{ {P}_{PUSCH , j\_o} ( i ) , ( {P}_{CMAX} ( i ) - {P}_{PUSCH , k\_o} ( i + 1 ) ) \} & ( 12 )\end{matrix}$$

where w(i) represents a weighting factor, whose value range is [0, 1]; c represents a cell;

$${\sum }_{c} w ( i ) \cdot {P}_{PUSCH , c} ( i )$$

represents eighth transmission power of a PUSCH bearing no uplink control signaling of the cell in the current subframe and the another cell which processes carrier aggregation with the cell in the current subframe; P_{CMAX}(i) represents maximum allowable power of the current subframe; P_{PUSCH,k}(t) represents third transmission power, which is obtained by the user equipment by performing uplink power control, of a PUSCH bearing uplink signaling of the cell in the adjacent subframe and the another cell which processes carrier aggregation with the cell in the adjacent subframe; P_{PUSCH,j}_{_{—}}ₒ(i) represents third transmission power, which is obtained by the user equipment by performing uplink power control, of the PUSCH bearing uplink signaling included in the current frame; P_{PUSCH,k}_{_{—}}ₒ(i−1) represents first transmission power of a PUSCH bearing uplink signaling of the another cell which processes carrier aggregation with the cell in an adjacent subframe before the current subframe; and P_{PUSCH,k}_{_{—}}ₒ(i−1) represents first transmission power of a PUSCH bearing uplink signaling of the another cell which processes carrier aggregation with the cell in an adjacent subframe after the current subframe.

It should be noted that, if the priority of the adjacent subframe before the current subframe is higher than the priority of the current subframe, the user equipment may perform relevant processing according to formulas (10) and (11); if the priority of the adjacent subframe after the current subframe is higher than the priority of the current subframe, the user equipment may perform relevant processing according to formulas (10) and (12).

In 102, the user equipment may also specifically determine, according to formula (13), ninth transmission power of the PUSCH of the cell in the current subframe and the another cell which processes carrier aggregation with the cell in the current subframe, where:

$${\sum }_{c \neq j} w ( i ) \cdot {P}_{PUSCH , c} ( i ) + u ( i ) \cdot {P}_{PUSCH , j} ( i ) + v ( i ) \cdot {P}_{PUSCH , k} ( t ) \leq {P}_{CMAX} ( i ) \qquad ( 13 )$$

where w(i), u(i), and v(i) represent weighting factors, whose value range is [0, 1]; c represents a cell;

$${\sum }_{c \neq j} w ( i ) \cdot {P}_{PUSCH , c} ( i )$$

represents ninth transmission power of a PUSCH bearing no uplink control signaling of the cell in the current subframe and the another cell which processes carrier aggregation with the cell in the current subframe; P_{CMAX}(i) represents maximum allowable power of the current subframe; P_{PUSCH,k}(t) represents the fourth transmission power, which is obtained by the user equipment by performing uplink power control, of a PUSCH bearing uplink signaling of the cell in the adjacent subframe and the another cell which processes carrier aggregation with the cell in the adjacent subframe; and P_{PUSCH,j}(i) represents third transmission power, which is obtained by the user equipment by performing uplink power control, of a PUSCH bearing uplink control signaling in the current subframe.

For example, the PUSCH of the cell in the current subframe and the another cell which processes carrier aggregation with the cell in the current subframe includes a PUSCH bearing uplink signaling, and the cell in the current subframe and the another cell which processes carrier aggregation with the cell in the current subframe further includes a PUCCH.

In 102, the user equipment may also specifically determine, according to formulas (14) and (15) or formulas (14) and (16), tenth transmission power of the PUSCH of the cell in the current subframe and the another cell which processes carrier aggregation with the cell in the current subframe, where:

$$\begin{matrix}{\sum }_{c \neq j} w ( i ) \cdot {P}_{PUSCH , c} ( i ) \leq ( {P}_{CMAX} ( i ) - {P}_{PUSCH , j} ( i ) - {P}_{PUSCH , k} ( t ) - {P}_{PUCCH} ( i ) ) & ( 14 ) \\ {P}_{PUSCH , j} ( i ) = min \{ {P}_{PUSCH , j\_o} ( i ) , ( {P}_{CMAX} ( i ) - {P}_{PUCCH} ( i ) - {P}_{PUSCH , k\_o} ( i - 1 ) ) \} & ( 15 ) \\ {P}_{PUSCH , j} ( i ) = min \{ {P}_{PUSCH , j\_o} ( i ) , ( {P}_{CMAX} ( i ) - {P}_{PUCCH} ( i ) - {P}_{PUSCH , k\_o} ( i + 1 ) ) \} & ( 16 )\end{matrix}$$

where w(i) represents a weighting factor, whose value range is [0, 1]; c represents a cell;

$${\sum }_{c \neq j} w ( i ) \cdot {P}_{PUSCH , c} ( i )$$

represents the tenth transmission power of a PUSCH bearing no uplink control signaling of the cell in the current subframe and the another cell which processes carrier aggregation with the cell in the current subframe; P_{PUCCH}(i) represents sixth transmission power, which is obtained by the user equipment by performing uplink power control, of the PUCCH of the cell or the another cell which processes carrier aggregation with the cell in the current subframe; P_{CMAX}(i) represents maximum allowable power of the current subframe; P_{PUSCH,k}(t) represents fifth transmission power, which is obtained by the user equipment by performing uplink power control, of a PUSCH bearing uplink signaling of the cell in the adjacent subframe and the another cell which processes carrier aggregation with the cell in the adjacent subframe; P_{PUSCH,j}_{_{—}}ₒ(i) represents fourth transmission power, which is obtained by the user equipment by performing uplink power control, of a PUSCH bearing uplink signaling included in the current frame; P_{PUSCH,k}_{_{—}}ₒ(i−1) represents second transmission power of a PUSCH bearing uplink signaling of the another cell which processes carrier aggregation with the cell in an adjacent subframe before the current subframe; or P_{PUSCH,k}_{_{—}}ₒ(i+1) represents second transmission power of a PUSCH bearing uplink signaling of the another cell which processes carrier aggregation with the cell in an adjacent subframe after the current subframe.

It should be noted that, if the priority of the adjacent subframe before the current subframe is higher than the priority of the current subframe, the user equipment may perform relevant processing according to formulas (14) and (15); if the priority of the adjacent subframe after the current subframe is higher than the priority of the current subframe, the user equipment may perform relevant processing according to formulas (14) and (16).

In 102, the user equipment may also specifically determine, according to formula (17), eleventh transmission power of the PUSCH of the cell in the current subframe and the another cell which processes carrier aggregation with the cell in the current subframe, where:

$${\sum }_{c \neq j} w ( i ) \cdot {P}_{PUSCH , c} ( i ) + u ( i ) \cdot {P}_{PUSCH , j} ( i ) + v ( i ) \cdot {P}_{PUSCH , k} ( t ) \leq {P}_{CMAX} ( i ) - {P}_{PUCCH} ( i ) \qquad ( 17 )$$

were w(i), u(i), and v(i) and represent weighting factors, whose value range is [0, 1]; c represents a cell;

$${\sum }_{c \neq j} w ( i ) \cdot {P}_{PUSCH , c} ( i )$$

represents eleventh transmission power of a PUSCH bearing no uplink control signaling of the cell in the current subframe and the another cell which processes carrier aggregation with the cell in the current subframe; P_{PUCCH}(i) represents seventh transmission power, which is obtained by the user equipment by performing uplink power control, of the PUCCH of the cell or the another cell which processes carrier aggregation with the cell in the current subframe; P_{CMAX}(i) represents maximum allowable power of the current subframe; P_{PUSCH,j}(i) represents fourth transmission power, which is obtained by the user equipment by performing uplink power control, of a PUSCH bearing uplink control signaling in the current subframe; and P_{PUSCH,k}(t) represents sixth transmission power, which is obtained by the user equipment by performing uplink power control, of a PUSCH bearing uplink signaling of the cell in the adjacent subframe and the another cell which processes carrier aggregation with the cell in the adjacent subframe.

According to another optional implementation mode provided in embodiments of the present invention, in 101, the overlap determined by the user equipment includes: the PUSCH of the cell in the current subframe is overlapped with a PUCCH of the another cell in a first adjacent subframe, the another cell being carrier aggregation with the cell, and the PUSCH of the cell in the current subframe, or the PUCCH of the cell in the current subframe, or at least one of the PUSCH and a PUCCH of the cell in the current subframe is overlapped with a PUSCH bearing uplink signaling of the another cell in a second adjacent subframe, the another cell being carrier aggregation with the cell. The first adjacent subframe may be the same as or different from the second adjacent subframe, which is not limited in embodiments of the present invention.

For example, in 102, the user equipment may also specifically determine, according to formula (18), twelfth transmission power of the PUSCH of the cell in the current subframe and the another cell which processes carrier aggregation with the cell in the current subframe, where:

$${\sum }_{c} w ( i ) \cdot {P}_{PUSCH , c} ( i ) \leq ( {P}_{CMAX} ( i ) - {P}_{PUSCH , k} ( t 2 ) - max ( {P}_{PUCCH} ( i ) , {P}_{PUCCH} ( t 1 ) ) ) \qquad ( 18 )$$

where w(i) represents a weighting factor, whose value range is [0, 1]; c represents a cell;

$${\sum }_{c} w ( i ) \cdot {P}_{PUSCH , c} ( i )$$

represents the twelfth transmission power of the PUSCH of the cell in the current subframe and the another cell which processes carrier aggregation with the cell in the current subframe; P_{PUCCH}(i) represents eighth transmission power, which is obtained by the user equipment by performing uplink power control, of the PUCCH of the another cell which processes carrier aggregation with the cell in the current subframe; P_{PUCCH}(t1) represents first transmission power, which is obtained by the user equipment by performing uplink power control, of a PUCCH of the another cell which processes carrier aggregation with the cell in the first adjacent subframe; P_{CMAX}(i) represents maximum allowable power of the current subframe; and P_{PUSCH,k}(t) represents first transmission power, which is obtained by the user equipment by performing uplink power control, of a PUSCH bearing uplink control signaling of the cell in the second adjacent subframe and the another cell which processes carrier aggregation with the cell in the second adjacent subframe.

For example, in 102, the user equipment may also specifically determine, according to formula (19), thirteenth transmission power of the PUSCH of the cell in the current subframe and the another cell which processes carrier aggregation with the cell in the current subframe, where:

$${\sum }_{c} w ( i ) \cdot {P}_{PUSCH , c} ( i ) + u ( i ) \cdot {P}_{PUSCH , k} ( t 2 ) \leq ( {P}_{CMAX} ( i ) - max ( {P}_{PUCCH} ( i ) , {P}_{PUCCH} ( t 1 ) ) ) \qquad ( 19 )$$

where w(i) and u(i) represent weighting factors, whose value range is [0, 1]; c represents a cell;

$${\sum }_{c} w ( i ) \cdot {P}_{PUSCH , c} ( i )$$

represents the thirteenth transmission power of the PUSCH of the cell in the current subframe and the another cell which processes carrier aggregation with the cell in the current subframe; P_{PUCCH}(i) represents ninth transmission power, which is obtained by the user equipment by performing uplink power control, of the PUCCH of the another cell which processes carrier aggregation with the cell in the current subframe; P_{PUCCH}(t1) represents second transmission power, which is obtained by the user equipment by performing uplink power control, of the PUCCH of the another cell which processes carrier aggregation with the cell in the first adjacent subframe; P_{CMAX}(i) represents maximum allowable power of the current subframe; and P_{PUSCH,k}(t2) represents second transmission power, which is obtained by the user equipment by performing uplink power control, of the PUSCH bearing uplink control signaling of the cell in the second adjacent subframe and the another cell which processes carrier aggregation with the cell in the second adjacent subframe.

For example, the PUSCH of the cell in the current subframe and the another cell which processes carrier aggregation with the cell in the current subframe includes a PUSCH bearing uplink signaling.

In 102, the user equipment may also specifically determine, according to formulas (20) and (21) or formulas (20) and (22), fourteenth transmission power of the PUSCH of the cell in the current subframe and the another cell which processes carrier aggregation with the cell in the current subframe, where:

$$\begin{matrix}{\sum }_{c \neq j} w ( i ) \cdot {P}_{PUSCH , c} ( i ) \leq ( {P}_{CMAX} ( i ) - {P}_{PUSCH , j} ( i ) - {P}_{PUSCH , k} ( t 2 ) - {P}_{PUCCH} ( t 1 ) ) & ( 20 ) \\ {P}_{PUSCH , j} ( i ) = min \{ {P}_{PUSCH , j\_o} ( i ) , ( {P}_{CMAX} ( i ) - {P}_{PUSCH , k\_o} ( i - 1 ) ) \} & ( 21 ) \\ {P}_{PUSCH , j} ( i ) = min \{ {P}_{PUSCH , j\_o} ( i ) , ( {P}_{CMAX} ( i ) - {P}_{PUSCH , k\_o} ( i + 1 ) ) \} & ( 22 )\end{matrix}$$

where w(i) represents a weighting factor, whose value range is [0, 1]; c represents a cell;

$${\sum }_{c \neq j} w ( i ) \cdot {P}_{PUSCH , c} ( i )$$

represents fourteenth transmission power of a PUSCH bearing no uplink control signaling of the cell in the current subframe and the another cell which processes carrier aggregation with the cell in the current subframe; P_{PUCCH}(t1) represents third transmission power, which is obtained by the user equipment by performing uplink power control, of the PUCCH of the another cell which processes carrier aggregation with the cell in the first adjacent subframe; P_{CMAX}(i) represents maximum allowable power of the current subframe; P_{PUSCH,j}_{_{—}}ₒ(i) represents fifth transmission power, which is obtained by the user equipment by performing uplink power control, of the PUSCH bearing uplink signaling in the current frame; P_{PUSCH,k}(t2) represents third transmission power, which is obtained by the user equipment by performing uplink power control, of a PUSCH bearing uplink signaling of the cell in the second adjacent subframe and the another cell which processes carrier aggregation with the cell in the second adjacent subframe; P_{PUSCH,k}_{_{—}}ₒ(i−1) represents third transmission power of a PUSCH bearing uplink signaling of the another cell which processes carrier aggregation with the cell in a second adjacent subframe before the current subframe; or P_{PUSCH,k}_{_{—}}ₒ(i+1) represents third transmission power of a PUSCH bearing uplink signaling of the another cell which processes carrier aggregation with the cell in a second adjacent subframe after the current subframe.

It should be noted that if the priority of the second adjacent subframe before the current subframe is higher than the priority of the current subframe, the user equipment may perform relevant processing according to formulas (20) and (21); if the priority of the second adjacent subframe after the current subframe is higher than the priority of the current subframe, the user equipment may perform relevant processing according to formulas (20) and (22).

In 102, the user equipment may also specifically determine, according to formula (23), fifteenth transmission power of the PUSCH of the cell in the current subframe and the another cell which processes carrier aggregation with the cell in the current subframe, where:

$${\sum }_{c \neq j} w ( i ) \cdot {P}_{PUSCH , c} ( i ) + u ( i ) \cdot {P}_{PUSCH , j} ( i ) + v ( i ) \cdot {P}_{PUSCH , k} ( t 2 ) \leq ( {P}_{CMAX} ( i ) - {P}_{PUCCH} ( t 1 ) ) \qquad ( 23 )$$

where w(i), u(i), and v(i) represent weighting factors, whose value range is [0, 1]; c represents a cell;

$${\sum }_{c \neq j} w ( i ) \cdot {P}_{PUSCH , c} ( i )$$

represents fifteenth transmission power of a PUSCH bearing no uplink control signaling of the cell in the current subframe and the another cell which processes carrier aggregation with the cell in the current subframe; P_{PUCCH}(t1) represents fourth transmission power, which is obtained by the user equipment by performing uplink power control, of the PUCCH of the another cell which processes carrier aggregation with the cell in the first adjacent subframe; P_{CMAX}(i) represents maximum allowable power of the current subframe; P_{PUSCH,j}_{_{—}}ₒ(i) represents sixth transmission power, which is obtained by the user equipment by performing uplink power control, of a PUSCH bearing uplink signaling in the current frame; P_{PUSCH,j}(i) represents fifth transmission power, which is obtained by the user equipment by performing uplink power control, of the PUSCH bearing uplink control signaling in the current subframe; and P_{PUSCH,k}(t2) represents fourth transmission power, which is obtained by the user equipment by performing uplink power control, of a PUSCH bearing uplink signaling of the cell in the second adjacent subframe and the another cell which processes carrier aggregation with the cell in the second adjacent subframe.

For example, the PUSCH of the cell in the current subframe and the another cell which processes carrier aggregation with the cell in the current subframe includes a PUSCH bearing uplink control signaling, and the cell in the current subframe and the another cell which processes carrier aggregation with the cell in the current subframe further includes a PUCCH.

In 102, the user equipment may also specifically determine, according to formulas (24) and (25) or formulas (24) and (26), sixteenth transmission power of the PUSCH of the cell in the current subframe and the another cell which processes carrier aggregation with the cell in the current subframe, where:

$$\begin{matrix}{\sum }_{c \neq j} w ( i ) \cdot {P}_{PUSCH , c} ( i ) \leq ( {P}_{CMAX} ( i ) - {P}_{PUSCH , j} ( i ) - {P}_{PUSCH , k} ( t 2 ) - max ( {P}_{PUCCH} ( i ) , {P}_{PUCCH} ( t 1 ) ) ) & ( 24 ) \\ {P}_{PUSCH , j} ( i ) = min \{ {P}_{PUSCH , j\_o} ( i ) , ( {P}_{CMAX} ( i ) - {P}_{PUCCH} ( i ) - {P}_{PUSCH , k\_o} ( i - 1 ) ) \} & ( 25 ) \\ {P}_{PUSCH , j} ( i ) = min \{ {P}_{PUSCH , j\_o} ( i ) , ( {P}_{CMAX} ( i ) - {P}_{PUCCH} ( i ) - {P}_{PUSCH , k\_o} ( i + 1 ) ) \} & ( 26 )\end{matrix}$$

where w(i) represents a weighting factor, whose value range is [0, 1]; c represents a cell;

$${\sum }_{c \neq j} w ( i ) \cdot {P}_{PUSCH , c} ( i )$$

represents sixteenth transmission power of a PUSCH bearing no uplink control signaling of the cell in the current subframe and the another cell which processes carrier aggregation with the cell in the current subframe; P_{PUCCH}(t1) represents fifth transmission power, which is obtained by the user equipment by performing uplink power control, of the PUCCH of the another cell which processes carrier aggregation with the cell in the first adjacent subframe; P_{PUCCH}(i) represents tenth transmission power, which is obtained by the user equipment by performing uplink power control, of the PUCCH of the another cell which processes carrier aggregation with the cell in the current subframe; P_{CMAX}(i) represents maximum allowable power of the current subframe; P_{PUSCH,j}_{_{—}}ₒ(i) represents sixth transmission power, which is obtained by the user equipment by performing uplink power control, of the PUSCH bearing uplink signaling in the current frame; P_{PUSCH,k}(t2) represents fifth transmission power, which is obtained by the user equipment by performing uplink power control, of a PUSCH bearing uplink signaling of the cell in the second adjacent subframe and the another cell which processes carrier aggregation with the cell in the second adjacent subframe; P_{PUSCH,k}_{_{—}}ₒ(i−1) represents fourth transmission power of a PUSCH bearing uplink signaling of the another cell which processes carrier aggregation with the cell in a second adjacent subframe before the current subframe; and P_{PUSCH,k}_{_{—}}ₒ(i+1) represents fourth transmission power of a PUSCH bearing uplink signaling of the another cell which processes carrier aggregation with the cell in a second adjacent subframe after the current subframe.

It should be noted that if the priority of the second adjacent subframe before the current subframe is higher than the priority of the current subframe, the user equipment may perform relevant processing according to formulas (24) and (25); if the priority of the second adjacent subframe after the current subframe is higher than the priority of the current subframe, the user equipment may perform relevant processing according to formulas (24) and (26).

In 102, the user equipment may also specifically determine according to formula (27), seventeenth transmission power of the PUSCH of the cell in the current subframe and the another cell which processes carrier aggregation with the cell in the current subframe, where:

$${\sum }_{c \neq j} w ( i ) \cdot {P}_{PUSCH , c} ( i ) + u ( i ) \cdot {P}_{PUSCH , j} ( i ) + v ( i ) \cdot {P}_{PUSCH , k} ( t 2 ) \leq ( {P}_{CMAX} ( i ) - max ( {P}_{PUCCH} ( i ) , {P}_{PUCCH} ( t 1 ) ) ) \qquad ( 27 )$$

where w(i), u(i), and v(i) represent weighting factors, whose value range is [0, 1]; c represents a cell;

$${\sum }_{c \neq j} w ( i ) \cdot {P}_{PUSCH , c} ( i )$$

represents seventeenth transmission power of a PUSCH bearing no uplink control signaling of the cell in the current subframe and the another cell which processes carrier aggregation with the cell in the current subframe; P_{PUCCH}(t1) represents sixth transmission power, which is obtained by the user equipment by performing uplink power control, of the PUCCH of the another cell which processes carrier aggregation with the cell in the first adjacent subframe; P_{PUCCH}(i) represents eleventh transmission power, which is obtained by the user equipment by performing uplink power control, of the PUCCH of the another cell which processes carrier aggregation with the cell in the current subframe; P_{CMAX} (i) represents maximum allowable power of the current subframe; P_{PUSCH,j}(i) represents sixth transmission power of a PUSCH bearing uplink control signaling in the current subframe; and P_{PUSCH,k}(t2) represents the sixth transmission power, which is obtained by the user equipment by performing uplink power control, of a PUSCH bearing uplink signaling of the cell in the second adjacent subframe and the another cell which processes carrier aggregation with the cell in the second adjacent subframe.

It should be noted that, if the other cells subjected to carrier aggregation with the cell in the current subframe do not have a PUCCH, the transmission power of the PUCCH may be 0.

In this embodiment, user equipment determines an overlap between an uplink channel of a cell in a current subframe and an uplink channel of the another cell which processes carrier aggregation with the cell in an adjacent subframe, so that the user equipment can determine transmission power of a PUSCH of the cell in the current subframe and the another cell which processes carrier aggregation with the cell in the current subframe. As a result, the problem that the uplink power control performed by the user equipment according to the prior art is not accurate is solved and thus the uplink data transmitting quality is improved.

It should be noted that, for brevity, the foregoing method embodiments are represented as a series of actions. But persons skilled in the art should understand that the present invention is not limited to the order of the described actions, because according to the present invention, some steps may adopt other order or occur simultaneously. It should be further understood by persons skilled in the art that the described embodiments all belong to exemplary embodiments, and the involved actions and modules are not necessarily required by the present invention.

In the foregoing embodiments, the description of each of the embodiments has respective focuses. For a part that is not described in detail in a certain embodiment, reference may be made to related descriptions in other embodiments.

FIG. 2 is a schematic structural diagram of a user equipment according to another embodiment of the present invention. As shown in FIG. 2, the user equipment according to this embodiment may include an overlap determining unit 21 and a power determining unit 22. The overlap determining unit 21 is configured to determine an overlap between an uplink channel of a cell in a current subframe and an uplink channel of another cell in an adjacent subframe, the cell being carrier aggregation with the another cell. The power determining unit 22 is configured to determine according to the overlap determined by the overlap determining unit 21, transmission power of a PUSCH of the cell in the current subframe and the another cell in the current subframe, the cell being carrier aggregation with the another cell.

Functions of the user equipment illustrated in above embodiments corresponding to FIG. 1 may be implemented by the user equipment provided in this embodiment.

According to an optional implementation mode provided in the embodiment of the present invention, the overlap determined by the overlap determining unit 21 may include: the PUSCH of the cell in the current subframe is overlapped with a PUCCH of the another cell in the adjacent subframe, the another cell being carrier aggregation with the cell.

For example, the power determining unit 22 may specifically determine according to formula (1), first transmission power of the PUSCH of the cell in the current subframe and the another cell which processes carrier aggregation with the cell in the current subframe, where:

$${\sum }_{c} w ( i ) \cdot {P}_{PUSCH , c} ( i ) \leq ( {P}_{CMAX} ( i ) - max ( {P}_{PUCCH} ( i ) , {P}_{PUCCH} ( t ) ) ) \qquad ( 1 )$$

where w(i) represents a weighting factor, whose value range is [0, 1]; c represents a cell;

$${\sum }_{c} w ( i ) \cdot {P}_{PUSCH , c} ( i )$$

represents the first transmission power of the PUSCH of the cell in the current subframe and the another cell which processes carrier aggregation with the cell in the current subframe; P_{PUCCH}(i) represents first transmission power, which is obtained by the user equipment by performing uplink power control, of a PUCCH of the another cell which processes carrier aggregation with the cell in the current subframe; P_{PUCCH}(t) represents first transmission power, which is obtained by the user equipment by performing uplink power control, of the PUCCH of the another cell which processes carrier aggregation with the cell in the adjacent subframe; and P_{CMAX}(i) represents maximum allowable power of the current subframe.

For example, the PUSCH of the cell in the current subframe and the another cell which processes carrier aggregation with the cell in the current subframe includes a PUSCH bearing uplink signaling.

The power determining unit 22 may further determine, according to formulas (2) and (3), second transmission power of the PUSCH of the cell in the current subframe and the another cell which processes carrier aggregation with the cell in the current subframe, where:

$$\begin{matrix}{\sum }_{c \neq j} w ( i ) \cdot {P}_{PUSCH , c} ( i ) \leq ( {P}_{CMAX} ( i ) - {P}_{PUCCH , j} ( i ) - {P}_{PUCCH} ( t ) ) & ( 2 ) \\ {P}_{PUSCH , j} ( i ) = min \{ {P}_{PUSCH , j\_o} ( i ) , ( {P}_{CMAX} ( i ) - {P}_{PUCCH} ( t ) ) \} & ( 3 )\end{matrix}$$

where w(i) represents a weighting factor, whose value range is [0, 1]; c represents a cell;

$${\sum }_{c \neq j} w ( i ) \cdot {P}_{PUSCH , c} ( i )$$

represents second transmission power of a PUSCH bearing no uplink control signaling of the cell in the current subframe, and in the another cell which processes carrier aggregation with the cell in the current subframe; P_{PUCCH}(t) represents second transmission power, which is obtained by the user equipment by performing uplink power control, of the PUCCH of the another cell which processes carrier aggregation with the cell in the current subframe; P_{CMAX}(i) represents maximum allowable power of the current subframe; and P_{PUSCH,j}_{_{—}}ₒ(i) represents first transmission power, which is obtained by the user equipment by performing uplink power control, of the PUSCH bearing uplink signaling in the current subframe.

The power determining unit 22 may further determine, according to formula (4), third transmission power of the PUSCH of the cell in the current subframe and the another cell which processes carrier aggregation with the cell in the current subframe, where:

$${\sum }_{c \neq j} w ( i ) \cdot {P}_{PUSCH , c} ( i ) + u ( i ) \cdot {P}_{PUSCH , j} ( i ) \leq ( {P}_{CMAX} ( i ) - {P}_{PUCCH} ( t ) ) \qquad ( 4 )$$

where w(i) and u(i) represent weighting factors, whose value range is [0, 1]; c represents a cell;

$${\sum }_{c \neq j} w ( i ) \cdot {P}_{PUSCH , c} ( i )$$

represents third transmission power of a PUSCH bearing no uplink control signaling of the cell in the current subframe, and in the another cell which processes carrier aggregation with the cell in the current subframe; P_{PUCCH}(t) represents third transmission power, which is obtained by the user equipment by performing uplink power control, of the PUCCH of the another cell which processes carrier aggregation with the cell in the current subframe; P_{CMAX}(i) represents maximum allowable power of the current subframe; and P_{PUSCH,j}(i) represents first transmission power, which is obtained by the user equipment by performing uplink power control, of the PUSCH bearing uplink control signaling in the current subframe.

For example, the PUSCH of the cell in the current subframe and the another cell which processes carrier aggregation with the cell in the current subframe includes a PUSCH bearing uplink control signaling, and the cell in the current subframe and the another cell which processes carrier aggregation with the cell in the current subframe further includes a PUCCH.

The power determining unit 22 may further determine, according to formulas (5) and (6), fourth transmission power of the PUSCH of the cell in the current subframe and the another cell which processes carrier aggregation with the cell in the current subframe, where:

$$\begin{matrix}{\sum }_{c \neq j} w ( i ) \cdot {P}_{PUSCH , c} ( i ) \leq ( {P}_{CMAX} ( i ) - {P}_{PUSCH , j} ( i ) - max ( {P}_{PUCCH} ( i ) , {P}_{PUCCH} ( t ) ) ) & ( 5 ) \\ {P}_{PUSCH , j} ( i ) = min \{ {P}_{PUSCH , j\_o} ( i ) , ( {P}_{CMAX} ( i ) - max ( {P}_{PUCCH} ( i ) , {P}_{PUCCH} ( t ) ) ) \} & ( 6 )\end{matrix}$$

where w(i) represents a weighting factor, whose value range is [0, 1]; c represents a cell;

$${\sum }_{c \neq j} w ( i ) \cdot {P}_{PUSCH , c} ( i )$$

represents fourth transmission power of a PUSCH bearing no uplink control signaling of the cell in the current subframe and the another cell which processes carrier aggregation with the cell in the current subframe; P_{PUCCH}(i) represents second transmission power, which is obtained by the user equipment by performing uplink power control, of the PUCCH of the another cell which processes carrier aggregation with the cell in the current subframe; P_{PUCCH}(t) represents fourth transmission power, which is obtained by the user equipment by performing uplink power control, of the PUCCH of the another cell which processes carrier aggregation with the cell in the adjacent subframe; P_{CMAX}(i) represents maximum allowable power of the current subframe; and P_{PUSCH,j}_{_{—}}ₒ(i) represents second transmission power, which is obtained by the user equipment by performing uplink power control, of a PUSCH bearing uplink signaling included in the current frame.

The power determining unit 22 may further determine, according to formula (7), fifth transmission power of the PUSCH of the cell in the current subframe and the another cell which processes carrier aggregation with the cell in the current subframe, where:

$${\sum }_{c \neq j} w ( i ) \cdot {P}_{PUSCH , c} ( i ) + u ( i ) \cdot {P}_{PUSCH , j} ( i ) \leq ( {P}_{CMAX} ( i ) - max ( {P}_{PUCCH} ( i ) , {P}_{PUCCH} ( t ) ) ) \qquad ( 7 )$$

where w(i) and u(i) represent weighting factors, whose value range is [0, 1]; c represents a cell;

$${\sum }_{c \neq j} w ( i ) \cdot {P}_{PUSCH , c} ( i )$$

represents fifth transmission power of a PUSCH bearing no uplink control signaling of the cell in the current subframe and the another cell which processes carrier aggregation with the cell in the current subframe; P_{PUCCH}(i) represents third transmission power, which is obtained by the user equipment by performing uplink power control, of the PUCCH of the another cell which processes carrier aggregation with the cell in the current subframe; P_{PUCCH}(t) represents fifth transmission power, which is obtained by the user equipment by performing uplink power control, of the PUCCH of the another cell which processes carrier aggregation with the cell in the adjacent subframe; P_{CMAX}(i) represents maximum allowable power of the current subframe; and P_{PUSCH,j}(i) represents second transmission power, which is obtained by the user equipment by performing uplink power control, of the PUSCH bearing uplink control signaling in the current subframe.

According to another optional implementation mode provided in the embodiment of the present invention, the overlap determined by the overlap determining unit 21 may further include: the PUSCH of the cell in the current subframe, or a PUCCH of the cell in the current subframe, or at least one of PUSCH and the PUCCH of the cell in the current subframe is overlapped with a PUSCH bearing uplink signaling in the another cell, in the adjacent subframe, the another cell being carrier aggregation with the cell.

For example, the power determining unit 22 may specifically determine, according to formula (8), sixth transmission power of the PUSCH of the cell in the current subframe and the another cell which processes carrier aggregation with the cell in the current subframe, where:

$${\sum }_{c} w ( i ) \cdot {P}_{PUSCH , c} ( i ) \leq ( {P}_{CMAX} ( i ) - {P}_{PUSCH , k} ( t ) - {P}_{PUCCH} ( i ) ) \qquad ( 8 )$$

where w(i) represents a weighting factor, whose value range is [0, 1]; c represents a cell;

$${\sum }_{c} w ( i ) \cdot {P}_{PUSCH , c} ( i )$$

represents the sixth transmission power of the PUSCH of the cell in the current subframe and the another cell which processes carrier aggregation with the cell in the current subframe; P_{PUCCH}(i) represents fourth transmission power, which is obtained by the user equipment by performing uplink power control, of the PUCCH of the cell or the another cell which processes carrier aggregation with the cell in the current subframe; P_{CMAX}(i) represents maximum allowable power of the current subframe; and P_{PUSCH,k}(t) represents first transmission power, which is obtained by the user equipment by performing uplink power control, of the PUSCH bearing uplink control signaling of the cell in the adjacent subframe and the another cell which processes carrier aggregation with the cell in the adjacent subframe.

The power determining unit 22 may further determine, according to formula (9), seventh transmission power of the PUSCH of the cell in the current subframe and the another cell which processes carrier aggregation with the cell in the current subframe, where:

$${\sum }_{c} w ( i ) \cdot {P}_{PUSCH , c} ( i ) + u ( i ) \cdot {P}_{PUSCH , k} ( t ) + v ( i ) \cdot {P}_{PUCCH} ( i ) \leq {P}_{CMAX} ( i ) \qquad ( 9 )$$

where w(i), u(i), and v(i) represent weighting factors, whose value range is [0, 1]; c represents a cell;

$${\sum }_{c} w ( i ) \cdot {P}_{PUSCH , c} ( i )$$

represents seventh transmission power of the PUSCH of the cell in the current subframe and the another cell which processes carrier aggregation with the cell in the current subframe; P_{PUCCH}(i) represents fifth transmission power, which is obtained by the user equipment by performing uplink power control, of the PUCCH of the cell or the another cell which processes carrier aggregation with the cell in the current subframe; P_{CMAX}(i) represents maximum allowable power of the current subframe; and P_{PUSCH,k}(t) represents second transmission power, which is obtained by the user equipment by performing uplink power control, of a PUSCH bearing uplink signaling of the cell in the adjacent subframe and the another cell which processes carrier aggregation with the cell in the adjacent subframe.

For example, the PUSCH of the cell in the current subframe and the another cell which processes carrier aggregation with the cell in the current subframe includes a PUSCH bearing uplink signaling.

The power determining unit 22 may further determine, according to formulas (10) and (11) or formulas (10) and (12), eighth transmission power of the PUSCH of the cell in the current subframe and the another cell which processes carrier aggregation with the cell in the current subframe, where:

$$\begin{matrix}{\sum }_{c \neq j} w ( i ) \cdot {P}_{PUSCH , c} ( i ) \leq ( {P}_{CMAX} ( i ) - {P}_{PUSCH , j} ( i ) - {P}_{PUSCH , k} ( t ) ) & ( 10 ) \\ {P}_{PUSCH , j} ( i ) = min \{ {P}_{PUSCH , j\_o} ( i ) , ( {P}_{CMAX} ( i ) - {P}_{PUSCH , k\_o} ( i - 1 ) ) \} & ( 11 ) \\ {P}_{PUSCH , j} ( i ) min \{ {P}_{PUSCH , j\_o} ( i ) , ( {P}_{CMAX} ( i ) - {P}_{PUSCH , k\_o} ( i + 1 ) ) \} & ( 12 )\end{matrix}$$

where w(i) represents a weighting factor, whose value range is [0, 1]; c represents a cell;

$${\sum }_{c \neq j} w ( i ) \cdot {P}_{PUSCH , c} ( i )$$

represents eighth transmission power of a PUSCH bearing no uplink control signaling of the cell in the current subframe and the another cell which processes carrier aggregation with the cell in the current subframe; P_{CMAX}(i) represents maximum allowable power of the current subframe; P_{PUSCH,k}(t) represents third transmission power, which is obtained by the user equipment by performing uplink power control, of the PUSCH bearing uplink signaling in the cell in the adjacent subframe and the another cell which processes carrier aggregation with the cell in the adjacent subframe; P_{PUSCH,j}_{_{—}}ₒ(i) represents third transmission power, which is obtained by the user equipment by performing uplink power control, of the PUSCH bearing uplink signaling in the current frame; P_{PUSCH,k}_{_{—}}ₒ₍ᵢ₋1) represents first transmission power of a PUSCH bearing uplink signaling of the another cell which processes carrier aggregation with the cell in an adjacent subframe before the current subframe; and P_{PUSCH,k}_{_{—}}ₒ(i+1) represents first transmission power of a PUSCH bearing uplink signaling in the another cell which processes carrier aggregation with the cell in an adjacent subframe after the current subframe.

It should be noted that if the priority of the adjacent subframe before the current subframe is higher than the priority of the current subframe, the user equipment may perform relevant processing according to formulas (10) and (11); if the priority of the adjacent subframe after the current subframe is higher than the priority of the current subframe, the user equipment may perform relevant processing according to formulas (10) and (12).

The power determining unit 22 may further determine, according to formula (13), ninth transmission power of the PUSCH of the cell in the current subframe and the another cell which processes carrier aggregation with the cell in the current subframe, where:

$${\sum }_{c \neq j} w ( i ) \cdot {P}_{PUSCH , c} ( i ) + u ( i ) \cdot {P}_{PUSCH , j} ( i ) + v ( i ) \cdot {P}_{PUSCH , k} ( t ) \leq {P}_{CMAX} ( i ) \qquad ( 13 )$$

where w(i), u(i), and v(i) represent weighting factors, whose value range is [0, 1]; c represents a cell;

$${\sum }_{c \neq j} w ( i ) \cdot {P}_{PUSCH , c} ( i )$$

represents ninth transmission power of a PUSCH bearing no uplink control signaling of the cell in the current subframe and the another cell which processes carrier aggregation with the cell in the current subframe; P_{CMAX}(i) represents maximum allowable power of the current subframe; P_{PUSCH,k}(t) represents the fourth transmission power, which is obtained by the user equipment by performing uplink power control, of a PUSCH bearing uplink signaling of the cell in the adjacent subframe and the another cell which processes carrier aggregation with the cell in the adjacent subframe; and P_{PUSCH,j}(i) represents third transmission power, which is obtained by the user equipment by performing uplink power control, of the PUSCH bearing uplink control signaling in the current subframe.

For example, the PUSCH of the cell in the current subframe and the another cell which processes carrier aggregation with the cell in the current subframe includes a PUSCH bearing uplink signaling, and the cell in the current subframe and the another cell which processes carrier aggregation with the cell in the current subframe further include a PUCCH.

The power determining unit 22 may further determine, according to formulas (14) and (15) or formulas (14) and (16), tenth transmission power of the PUSCH of the cell in the current subframe and the another cell which processes carrier aggregation with the cell in the current subframe, where:

$$\begin{matrix}{\sum }_{c \neq j} w ( i ) \cdot {P}_{PUSCH , c} ( i ) \leq ( {P}_{CMAX} ( i ) - {P}_{PUSCH , j} ( i ) - {P}_{PUSCH , k} ( t ) - {P}_{PUCCH} ( i ) ) & ( 14 ) \\ {P}_{PUSCH , j} ( i ) = min \{ {P}_{PUSCH , j\_o} ( i ) , ( {P}_{CMAX} ( i ) - {P}_{PUCCH} ( i ) - {P}_{PUSCH , k\_o} ( i - 1 ) ) \} & ( 15 ) \\ {P}_{PUSCH , j} ( i ) = min \{ {P}_{PUSCH , j\_o} ( i ) , ( {P}_{CMAX} ( i ) - {P}_{PUCCH} ( i ) - {P}_{PUSCH , k\_o} ( i + 1 ) ) \} & ( 16 )\end{matrix}$$

where w(i) represents a weighting factor, whose value range is [0, 1]; c represents a cell;

$${\sum }_{c \neq j} w ( i ) \cdot {P}_{PUSCH , c} ( i )$$

represents the tenth transmission power of a PUSCH bearing no uplink control signaling of the cell in the current subframe and the another cell which processes carrier aggregation with the cell in the current subframe; P_{PUCCH}(i) represents sixth transmission power, which is obtained by the user equipment by performing uplink power control, of the PUCCH of the cell or the another cell which processes carrier aggregation with the cell in the current subframe; P_{CMAX}(i) represents maximum allowable power of the current subframe; P_{PUSCH,k}(t) represents fifth transmission power, which is obtained by the user equipment by performing uplink power control, of a PUSCH bearing uplink signaling of the cell in the adjacent subframe and the another cell which processes carrier aggregation with the cell in the adjacent subframe; P_{PUSCH,j}_{_{—}}ₒ(i) represents fourth transmission power, which is obtained by the user equipment by performing uplink power control, of a PUSCH bearing uplink signaling in the current frame; P_{PUSCH,k}_{_{—}}ₒ(i−1) represents second transmission power of a PUSCH bearing uplink signaling of the another cell which processes carrier aggregation with the cell in an adjacent subframe before the current subframe; and P_{PUSCH,k}_{_{—}}ₒ(i+1) represents second transmission power of a PUSCH bearing uplink signaling of the another cell which processes carrier aggregation with the cell in an adjacent subframe after the current subframe.

It should be noted that, if the priority of the adjacent subframe before the current subframe is higher than the priority of the current subframe, the user equipment may perform relevant processing according to formulas (14) and (15); if the priority of the adjacent subframe after the current subframe is higher than the priority of the current subframe, the user equipment may perform relevant processing according to formulas (14) and (16).

The power determining unit 22 may further determine, according to formula (17), eleventh transmission power of the PUSCH of the cell in the current subframe and the another cell which processes carrier aggregation with the cell in the current subframe, where:

$${\sum }_{c \neq j} w ( i ) \cdot {P}_{PUSCH , c} ( i ) + u ( i ) \cdot {P}_{PUSCH , j} ( i ) + v ( i ) \cdot {P}_{PUSCH , k} ( t ) \leq {P}_{CMAX} ( i ) - {P}_{PUCCH} ( i ) \qquad ( 17 )$$

where w(i), u(i), and v(i) and represent weighting factors, whose value range is [0, 1]; c represents a cell;

$${\sum }_{c \neq j} w ( i ) \cdot {P}_{PUSCH , c} ( i )$$

represents eleventh transmission power of a PUSCH bearing no uplink control signaling of the cell in the current subframe and the another cell which processes carrier aggregation with the cell in the current subframe; P_{PUCCH}(i) represents seventh transmission power, which is obtained by the user equipment by performing uplink power control, of the PUCCH of the cell or the another cell which processes carrier aggregation with the cell in the current subframe; P_{CMAX}(i) represents maximum allowable power of the current subframe; P_{PUSCH,j}(i) represents fourth transmission power, which is obtained by the user equipment by performing uplink power control, of a PUSCH bearing uplink control signaling in the current subframe; and P_{PUSCH,k}(t) represents sixth transmission power, which is obtained by the user equipment by performing uplink power control, of a PUSCH bearing uplink signaling of the cell in the adjacent subframe and the another cell which processes carrier aggregation with the cell in the adjacent subframe.

According to another optional implementation mode provided in the embodiment of the present invention, the overlap determined by the overlap determining unit 21 may include: the PUSCH of the cell in the current subframe is overlapped with the PUCCH of the another cell in a first adjacent subframe, the another cell beings carrier aggregation with the cell, and the PUSCH of the cell in the current subframe, or the PUCCH of the cell in the current subframe, or at least one of the PUSCH and a PUCCH of the cell in the current subframe is overlapped with a PUSCH bearing uplink signaling of the another cell in a second adjacent subframe, the another cell being carrier aggregation with the cell. The first adjacent subframe may be the same as or different from the second adjacent subframe, which is not limited in embodiments of the present invention.

For example, the power determining unit 22 may specifically determine, according to formula (18), twelfth transmission power of the PUSCH of the cell in the current subframe and the another cell which processes carrier aggregation with the cell in the current subframe, where:

$${\sum }_{c} w ( i ) \cdot {P}_{PUSCH , c} ( i ) \leq ( {P}_{CMAX} ( i ) - {P}_{PUSCH , k} ( t 2 ) - max ( {P}_{PUCCH} ( i ) , {P}_{PUCCH} ( t 1 ) ) ) \qquad ( 18 )$$

where w(i) represents a weighting factor, whose value range is [0, 1]; c represents a cell;

$${\sum }_{c} w ( i ) \cdot {P}_{PUSCH , c} ( i )$$

represents the twelfth transmission power of the PUSCH of the cell in the current subframe and the another cell which processes carrier aggregation with the cell in the current subframe; P_{PUCCH}(i) represents eighth transmission power, which is obtained by the user equipment by performing uplink power control, of the PUCCH of the another cell which processes carrier aggregation with the cell in the current subframe; P_{PUCCH}(t1) represents first transmission power, which is obtained by the user equipment by performing uplink power control, of a PUCCH of the another cell which processes carrier aggregation with the cell in the first adjacent subframe; P_{CMAX}(i) represents maximum allowable power of the current subframe; and P_{PUSCH,k}(t) represents first transmission power, which is obtained by the user equipment by performing uplink power control, of the PUSCH bearing uplink control signaling of the cell in the second adjacent subframe and the another cell which processes carrier aggregation with the cell in the second adjacent subframe.

For example, the power determining unit 22 may further determine, according to formula (19), thirteenth transmission power of the PUSCH of the cell in the current subframe and the another cell which processes carrier aggregation with the cell in the current subframe, where:

$${\sum }_{c} w ( i ) \cdot {P}_{PUSCH , c} ( i ) + u ( i ) \cdot {P}_{PUSCH , k} ( t 2 ) \leq ( {P}_{CMAX} ( i ) - max ( {P}_{PUCCH} ( i ) , {P}_{PUCCH} ( t 1 ) ) ) \qquad ( 19 )$$

where w(i) and u(i) represent weighting factors, whose value range is [0, 1]; c represents a cell;

$${\sum }_{c} w ( i ) \cdot {P}_{PUSCH , c} ( i )$$

represents the thirteenth transmission power of the PUSCH of the cell in the current subframe and the another cell which processes carrier aggregation with the cell in the current subframe; P_{PUCCH}(i) represents ninth transmission power, which is obtained by the user equipment by performing uplink power control, of the PUCCH of the another cell which processes carrier aggregation with the cell in the current subframe; P_{PUCCH}(t1) represents second transmission power, which is obtained by the user equipment by performing uplink power control, of the PUCCH of the another cell which processes carrier aggregation with the cell in the first adjacent subframe; P_{CMAX}(i) represents maximum allowable power of the current subframe; and P_{PUSCH,k}(t2) represents second transmission power, which is obtained by the user equipment by performing uplink power control, of a PUSCH bearing uplink control signaling of the cell in the second adjacent subframe and the another cell which processes carrier aggregation with the cell in the second adjacent subframe.

For example, the PUSCH of the cell in the current subframe and the another cell which processes carrier aggregation with the cell in the current subframe includes a PUSCH bearing uplink signaling.

The power determining unit 22 may further determine, according to formulas (20) and (21) or formulas (20) and (22), fourteenth transmission power of the PUSCH of the cell in the current subframe and the another cell which processes carrier aggregation with the cell in the current subframe, where:

$$\begin{matrix}{\sum }_{c \neq j} w ( i ) \cdot {P}_{PUSCH , c} ( i ) \leq ( {P}_{CMAX} ( i ) - {P}_{PUSCH , j} ( i ) - {P}_{PUSCH , k} ( t 2 ) - {P}_{PUCCH} ( t 1 ) ) & ( 20 ) \\ {P}_{PUSCH , j} ( i ) = min \{ {P}_{PUSCH , j\_o} ( i ) , ( {P}_{CMAX} ( i ) - {P}_{PUSCH , k\_o} ( i - 1 ) ) \} & ( 21 ) \\ {P}_{PUSCH , j} ( i ) = min \{ {P}_{PUSCH , j\_o} ( i ) , ( {P}_{CMAX} ( i ) - {P}_{PUSCH , k\_o} ( i + 1 ) ) \} & ( 22 )\end{matrix}$$

where w(i) represents a weighting factor, whose value range is [0, 1]; c represents a cell;

$${\sum }_{c \neq j} w ( i ) \cdot {P}_{PUSCH , c} ( i )$$

represents fourteenth transmission power of a PUSCH bearing no uplink control signaling of the cell in the current subframe and the another cell which processes carrier aggregation with the cell in the current subframe; P_{PUCCH}(t1) represents third transmission power, which is obtained by the user equipment by performing uplink power control, of the PUCCH of the another cell which processes carrier aggregation with the cell in the first adjacent subframe; P_{CMAX}(i) represents maximum allowable power of the current subframe; P_{PUSCH,j}_{_{—}}ₒ(i) represents fifth transmission power, which is obtained by the user equipment by performing uplink power control, of the PUSCH bearing uplink signaling in the current frame; P_{PUSCH,k}(t2) represents third transmission power, which is obtained by the user equipment by performing uplink power control, of the PUSCH bearing uplink signaling of the cell in the second adjacent subframe and the another cell which processes carrier aggregation with the cell in the second adjacent subframe; P_{PUSCH,k}_{_{—}}ₒ(i−1) represents third transmission power of a PUSCH bearing uplink signaling of the another cell which processes carrier aggregation with the cell in a second adjacent subframe before the current subframe; and P_{PUSCH,k}_{_{—}}ₒ(i+1) represents third transmission power of a PUSCH bearing uplink signaling of the another cell which processes carrier aggregation with the cell in a second adjacent subframe after the current subframe.

It should be noted that, if the priority of the second adjacent subframe before the current subframe is higher than the priority of the current subframe, the user equipment may perform relevant processing according to formulas (20) and (21); if the priority of the second adjacent subframe after the current subframe is higher than the priority of the current subframe, the user equipment may perform relevant processing according to formulas (20) and (22).

The power determining unit 22 may further determine, according to formula (23), fifteenth transmission power of the PUSCH of the cell in the current subframe and the another cell which processes carrier aggregation with the cell in the current subframe, where:

$${\sum }_{c \neq j} w ( i ) \cdot {P}_{PUSCH , c} ( i ) + u ( i ) \cdot {P}_{PUSCH , j} ( i ) + v ( i ) \cdot {P}_{PUSCH , k} ( t 2 ) \leq ( {P}_{CMAX} ( i ) - {P}_{PUCCH} ( t 1 ) ) \qquad ( 23 )$$

where w(i), u(i), and v(i) represent weighting factors, whose value range is [0, 1]; c represents a cell;

$${\sum }_{c \neq j} w ( i ) \cdot {P}_{PUSCH , c} ( i )$$

represents fifteenth transmission power of the PUSCH bearing no uplink control signaling of the cell in the current subframe and the another cell which processes carrier aggregation with the cell in the current subframe; P_{PUCCH}(t1) represents fourth transmission power, which is obtained by the user equipment by performing uplink power control, of the PUCCH of the another cell which processes carrier aggregation with the cell in the first adjacent subframe; P_{CMAX}(i) represents maximum allowable power of the current subframe; P_{PUSCH,j}_{_{—}}ₒ(i) represents sixth transmission power of a PUSCH bearing uplink signaling in the current frame; P_{PUSCH,j}(i) represents fifth transmission power, which is obtained by the user equipment by performing uplink power control, of the PUSCH bearing uplink control signaling in the current subframe; and P_{PUSCH,k}(t2) represents fourth transmission power, which is obtained by the user equipment by performing uplink power control, of a PUSCH bearing uplink signaling in the cell in the second adjacent subframe and the another cell which processes carrier aggregation with the cell in the second adjacent subframe.

For example, the PUSCH of the cell in the current subframe and the another cell which processes carrier aggregation with the cell in the current subframe includes a PUSCH bearing uplink control signaling, and the cell in the current subframe and the another cell which processes carrier aggregation with the cell in the current subframe further include a PUCCH.

The power determining unit 22 may specifically determine, according to formulas (24) and (25) or formulas (24) and (26), sixteenth transmission power of the PUSCH of the cell in the current subframe and the another cell which processes carrier aggregation with the cell in the current subframe, where:

$$\begin{matrix}{\sum }_{c \neq j} w ( i ) \cdot {P}_{PUSCH , c} ( i ) \leq ( {P}_{CMAX} ( i ) - {P}_{PUSCH , j} ( i ) - {P}_{PUSCH , k} ( t 2 ) - max ( {P}_{PUCCH} ( i ) , {P}_{PUCCH} ( t 1 ) ) ) & ( 24 ) \\ {P}_{PUSCH , j} ( i ) = min \{ {P}_{PUSCH , j\_o} ( i ) , ( {P}_{CMAX} ( i ) - {P}_{PUCCH} ( i ) - {P}_{PUSCH , k\_o} ( i - 1 ) ) \} & ( 25 ) \\ {P}_{PUSCH , j} ( i ) = min \{ {P}_{PUSCH , j\_o} ( i ) , ( {P}_{CMAX} ( i ) - {P}_{PUCCH} ( i ) - {P}_{PUSCH , k\_o} ( i + 1 ) ) \} & ( 26 )\end{matrix}$$

where w(i) represents a weighting factor, whose value range is [0, 1]; c represents a cell;

$${\sum }_{c \neq j} w ( i ) \cdot {P}_{PUSCH , c} ( i )$$

represents sixteenth transmission power of a PUSCH bearing no uplink control signaling of the cell in the current subframe and the another cell which processes carrier aggregation with the cell in the current subframe; P_{PUCCH}(t1) represents fifth transmission power, which is obtained by the user equipment by performing uplink power control, of the PUCCH of the another cell which processes carrier aggregation with the cell in the first adjacent subframe; P_{PUCCH}(i) represents tenth transmission power, which is obtained by the user equipment by performing uplink power control, of the PUCCH of the another cell which processes carrier aggregation with the cell in the current subframe; P_{CMAX}(i) represents maximum allowable power of the current subframe; P_{PUSCH,j}_{_{—}}ₒ(i) represents sixth transmission power, which is obtained by the user equipment by performing uplink power control, of the PUSCH bearing uplink signaling in the current frame; P_{PUSCH,k}(t2) represents fifth transmission power of a PUSCH bearing uplink signaling of the cell in the second adjacent subframe and the another cell which processes carrier aggregation with the cell in the second adjacent subframe; P_{PUSCH,k}_{_{—}}ₒ(i−1) represents fourth transmission power of a PUSCH bearing uplink signaling of the another cell which processes carrier aggregation with the cell in a second adjacent subframe before the current subframe; and P_{PUSCH,k}_{_{—}}ₒ(i+1) represents fourth transmission power of a PUSCH bearing uplink signaling of the another cell which processes carrier aggregation with the cell in a second adjacent subframe after the current subframe.

It should be noted that, if the priority of the second adjacent subframe before the current subframe is higher than the priority of the current subframe, the user equipment may perform relevant processing according to formulas (24) and (25); if the priority of the second adjacent subframe after the current subframe is higher than the priority of the current subframe, the user equipment may perform relevant processing according to formulas (24) and (26).

The power determining unit 22 may further determine, according to formula (27), seventeenth transmission power of the PUSCH of the cell in the current subframe and the another cell which processes carrier aggregation with the cell in the current subframe, where:

$${\sum }_{c \neq j} w ( i ) \cdot {P}_{PUSCH , c} ( i ) + u ( i ) \cdot {P}_{PUSCH , j} ( i ) + v ( i ) \cdot {P}_{PUSCH , k} ( t 2 ) \leq ( {P}_{CMAX} ( i ) - max ( {P}_{PUCCH} ( i ) , {P}_{PUCCH} ( t 1 ) ) ) \qquad ( 27 )$$

where w(i), u(i), and v(i) represent weighting factors, whose value range is [0, I]; c represents a cell;

$${\sum }_{c \neq j} w ( i ) \cdot {P}_{PUSCH , c} ( i )$$

represents seventeenth transmission power of a PUSCH bearing no uplink control signaling of the cell in the current subframe and the another cell which processes carrier aggregation with the cell in the current subframe; P_{PUCCH}(t1) represents sixth transmission power, which is obtained by the user equipment by performing uplink power control, of the PUCCH of the another cell which processes carrier aggregation with the cell in the first adjacent subframe; P_{PUCCH}(i) represents eleventh transmission power, which is obtained by the user equipment by performing uplink power control, of the PUCCH of the another cell which processes carrier aggregation with the cell in the current subframe; P_{CMAX}(i) represents maximum allowable power of the current subframe; P_{PUSCH,j}(i) represents the sixth transmission power, which is obtained by the user equipment by performing uplink power control, of a PUSCH bearing uplink control signaling in the current subframe; and P_{PUSCH,k}(t2) represents sixth transmission power, which is obtained by the user equipment by performing uplink power control, of a PUSCH bearing uplink signaling of the cell in the second adjacent subframe and the another cell which processes carrier aggregation with the cell in the second adjacent subframe.

It should be noted that if the other cells subjected to carrier aggregation with the cell in the current subframe do not have a PUCCH, the transmission power of the PUCCH may be 0.

In this embodiment, the user equipment determines through the overlap determining unit, an overlap between an uplink channel of a cell in a current subframe and an uplink channel of the another cell which processes carrier aggregation with the cell in an adjacent subframe, so that the power determining unit can determine according to the overlap determined by the overlap determining unit, transmission power of a PUSCH of the cell in the current subframe and the another cell which processes carrier aggregation with the cell in the current subframe. As a result, the problem that the uplink power control performed by the user equipment according to the prior art is not accurate is solved and thus the uplink data transmitting quality is improved.

An embodiment of the present invention also provides a processor, which is configured to determine an overlap between an uplink channel of a cell in a current subframe and an uplink channel of the another cell which processes carrier aggregation with the cell in an adjacent subframe, and determine according to the determined overlap, transmission power of a physical uplink shared channel PUSCH of the cell in the current subframe and the another cell which processes carrier aggregation with the cell in the current subframe. The processor can be connected with a storage that is configured to store information processed by the processor. For actions performed by the processor, reference may be made to the uplink transmission power determining method provided in the foregoing embodiment, which is not repeated herein. The processor may exist in the user equipment or base station and is configured to determine uplink transmission power.

An embodiment of the present invention also provides a chip, which is configured to determine uplink transmission power. The chip may include the foregoing processor.

Persons skilled in the art may clearly understand that, for the purpose of convenient and brief description, for a detailed working process of the system, apparatus, and unit described foregoing, reference may be made to corresponding process in the method embodiments, and details will not be described herein again.

In the embodiments provided in the present application, it should be understood that the disclosed system, apparatus, and method may be implemented in other modes. For example, the described apparatus embodiment is merely exemplary. For example, the unit division is merely logical function division and may be other division in actual implementation. For example, a plurality of units or components may be combined or integrated into another system, or some features may be ignored or not performed. In addition, the displayed or discussed mutual couplings or direct couplings or communication connections may be implemented through some interfaces. The indirect couplings or communication connections between the apparatuses or units may be implemented in electronic, mechanical or other forms.

The units described as separate parts may or may not be physically separate, and parts displayed as units may or may not be physical units, may be located in one position, or may be distributed on multiple network units. A part or all of the units may be selected according to an actual need to achieve the objectives of the solutions of the embodiments.

In addition, functional units in embodiments of the present invention may be integrated into one processing unit, or each of the units may exist alone physically, or two or more units are integrated into one unit. The integrated unit may be implemented through hardware, or may also be implemented in a form of hardware plus a software functional module.

The integrated unit implemented in the form of software functional unit may be stored in a computer readable storage medium. The software functional unit is stored in a storage medium, and contains several instructions used to instruct computer equipment (for example, a personal computer, a server, or network equipment) to perform the steps of the methods according to the embodiments of the present invention. The storage medium may be any medium that can store program codes, such as a U disk, a removable hard disk, a read-only memory (ROM, Read-Only memory), a random access memory (RAM, Random Access Memory), a magnetic disk, or an optical disk.

Finally, it should be noted that the foregoing embodiments are merely intended for describing the technical solutions of the present invention other than limiting the present invention. Although the present invention is described in detail with reference to the foregoing embodiments, a person of ordinary skill in the art should understand that they may still make modifications to the technical solution described in the foregoing embodiments or make equivalent substitutions to some technical features thereof, without departing from the spirit and scope of the technical solution of embodiments of the present invention.

What is claimed is:

1. A method for determining an uplink transmission power, comprising:
determining, by a user equipment, an overlap between an uplink channel of a cell in a current subframe and an uplink channel of another cell in an adjacent subframe, the cell being carrier aggregation with the another cell; and
determining, by the user equipment, according to the determined overlap, transmission power of a physical uplink shared channel (PUSCH) of the cell in the current subframe and the another cell in the current subframe, the cell being carrier aggregation with the another cell.

2. The method according to claim 1, wherein: the overlap determined by the user equipment comprises: the PUSCH of the cell in the current subframe is overlapped with a physical uplink control channel (PUCCH) of the another cell in the adjacent subframe, the another cell being carrier aggregation with the cell.

3. The method according to claim 2, wherein: the determining, by the user equipment, according to the determined overlap, the transmission power of the PUSCH of the cell in the current subframe and the another cell in the current subframe, the cell being carrier aggregation with the another cell, comprises:
determining, by the user equipment, according to formula (1), first transmission power of the PUSCH of the cell in the current subframe and the another cell which processes carrier aggregation with the cell in the current subframe, wherein:
$${\sum }_{c} w ( i ) \cdot {P}_{PUSCH , c} ( i ) \leq ( {P}_{CMAX} ( i ) - max ( {P}_{PUCCH} ( i ) , {P}_{PUCCH} ( t ) ) ) \qquad ( 1 )$$
wherein w(i) represents a weighting factor, whose value range is [0, 1]; c represents a cell;
$${\sum }_{c} w ( i ) \cdot {P}_{PUSCH , c} ( i )$$
represents the first transmission power of the PUSCH of the cell in the current subframe and the another cell which processes carrier aggregation with the cell, in the current subframe; P_{PUCCH}(i) represents first transmission power, which is obtained by the user equipment by performing uplink power control, of a PUCCH of the another cell which processes carrier aggregation with the cell in the current subframe; P_{PUCCH}(t) represents first transmission power, which is obtained by the user equipment by performing uplink power control, of the PUCCH of the another cell which processes carrier aggregation with the cell in the adjacent subframe; P_{CMAX}(i) and represents maximum allowable power of the current subframe.

4. The method according to claim 2, wherein the PUSCH of the cell in the current subframe and the another cell which processes carrier aggregation with the cell in the current subframe comprises a PUSCH bearing uplink control signaling; and, the determining, by the user equipment, according to the determined overlap, the transmission power of the PUSCH of the cell in the current subframe and the another cell in the current subframe, the cell being carrier aggregation with the another cell, comprises:
determining, by the user equipment, according to formulas (2) and (3), second transmission power of the PUSCH of the cell in the current subframe and the another cell which processes carrier aggregation with the cell in the current subframe, wherein:
$$\begin{matrix}{\sum }_{c \neq j} w ( i ) \cdot {P}_{PUSCH , c} ( i ) \leq ( {P}_{CMAX} ( i ) - {P}_{PUSCH , j} ( i ) - {P}_{PUCCH} ( t ) ) & ( 2 ) \\ {P}_{PUSCH , j} ( i ) = min \{ {P}_{PUSCH , j\_o} ( i ) , ( {P}_{CMAX} ( i ) - {P}_{PUCCH} ( t ) ) \} & ( 3 )\end{matrix}$$
wherein w(i) represents a weighting factor, whose value range is [0, 1]; c represents a cell;
$${\sum }_{c \neq j} w ( i ) \cdot {P}_{PUSCH , c} ( i )$$
represents second transmission power of a PUSCH bearing no uplink control signaling of the cell in the current subframe and the another cell which processes carrier aggregation with the cell in the current subframe; P_{PUCCH}(t) represents second transmission power, which is obtained by the user equipment by performing uplink power control, of the PUCCH of the another cell which processes carrier aggregation with the cell in the adjacent subframe; P_{CMAX}(i) represents maximum allowable power of the current subframe; and P_{PUSCH,j}_{_{—}}ₒ(i) represents first transmission power, which is obtained by the user equipment by performing uplink power control, of a PUSCH bearing uplink signaling in the current subframe; or
determining, by the user equipment, according to formula (4), third transmission power of the PUSCH of the cell in the current subframe and the another cell which processes carrier aggregation with the cell in the current subframe, wherein:
$${\sum }_{c \neq j} w ( i ) \cdot {P}_{PUSCH , c} ( i ) + u ( i ) \cdot {P}_{PUSCH , j} ( i ) \leq ( {P}_{CMAX} ( i ) - {P}_{PUCCH} ( t ) ) \qquad ( 4 )$$
wherein w(i) and u(i) represent weighting factors, whose value range is [0, 1]; c represents a cell;
$${\sum }_{c \neq j} w ( i ) \cdot {P}_{PUSCH , c} ( i )$$
represents third transmission power of a PUSCH bearing no uplink control signaling of the cell in the current subframe and the another cell which processes carrier aggregation with the cell in the current subframe; P_{PUCCH}(t) represents third transmission power, which is obtained by the user equipment by performing uplink power control, of the PUCCH of the another cell which processes carrier aggregation with the cell in the adjacent subframe; P_{CMAX}(i) represents maximum allowable power of the current subframe; and P_{PUSCH,j}(i) represents first transmission power, which is obtained by the user equipment by performing uplink power control, of a PUSCH bearing uplink control signaling in the current subframe.

5. The method according to claim 2, wherein the PUSCH of the cell in the current subframe and the another cell which processes carrier aggregation with the cell in the current subframe comprises a PUSCH bearing uplink control signaling; the determining, by the user equipment, according to the determined overlap, the transmission power of the PUSCH of the cell in the current subframe and the another cell in the current subframe, the cell being carrier aggregation with the another cell, comprises:
determining, by the user equipment, according to formulas (5) and (6), fourth transmission power of the PUSCH of the cell in the current subframe and the another cell which processes carrier aggregation with the cell in the current subframe, wherein:
$$\begin{matrix}{\sum }_{c \neq j} w ( i ) \cdot {P}_{PUSCH , c} ( i ) \leq ( {P}_{CMAX} ( i ) - {P}_{PUSCH , j} ( i ) - max ( {P}_{PUCCH} ( i ) , {P}_{PUCCH} ( t ) ) ) & ( 5 ) \\ {P}_{PUSCH , j} ( i ) = min \{ {P}_{PUSCH , j\_o} ( i ) , ( {P}_{CMAX} ( i ) - max ( {P}_{PUCCH} ( i ) , {P}_{PUCCH} ( t ) ) ) \} & ( 6 )\end{matrix}$$
wherein w(i) represents a weighting factor, whose value range is [0, 1]; c represents a cell;
$${\sum }_{c \neq j} w ( i ) \cdot {P}_{PUSCH , c} ( i )$$
represents fourth transmission power of a PUSCH bearing no uplink control signaling of the cell in the current subframe and the another cell which processes carrier aggregation with the cell in the current subframe; P_{PUCCH}(i) represents second transmission power, which is obtained by the user equipment by performing uplink power control, of the PUCCH of the another cell which processes carrier aggregation with the cell in the current subframe; P_{PUCCH}(t) represents fourth transmission power, which is obtained by the user equipment by performing uplink power control, of the PUCCH of the another cell which processes carrier aggregation with the cell in the adjacent subframe; P_{CMAX}(i) represents maximum allowable power of the current subframe; and P_{PUSCH,j}_{_{—}}ₒ(i) represents second transmission power, which is obtained by the user equipment by performing uplink power control, of a PUSCH bearing uplink signaling comprised in the current frame; or
determining, by the user equipment, according to formula (7), fifth transmission power of the PUSCH of the cell in the current subframe and the another cell which processes carrier aggregation with the cell in the current subframe, wherein:
$${\sum }_{c \neq j} w ( i ) \cdot {P}_{PUSCH , c} ( i ) + u ( i ) \cdot {P}_{PUSCH , j} ( i ) \leq ( {P}_{CMAX} ( i ) - max ( {P}_{PUCCH} ( i ) , {P}_{PUCCH} ( t ) ) ) \qquad ( 7 )$$
wherein w(i) and u(i) represent weighting factors, whose value range is [0, 1]; c represents a cell;
$${\sum }_{c \neq j} w ( i ) \cdot {P}_{PUSCH , c} ( i )$$
represents fifth transmission power of a PUSCH bearing no uplink control signaling of the cell in the current subframe and the another cell which processes carrier aggregation with the cell in the current subframe; P_{PUCCH}(i) represents third transmission power, which is obtained by the user equipment by performing uplink power control, of the PUCCH of the another cell which processes carrier aggregation with the cell in the current subframe; P_{PUCCH}(t) represents fifth transmission power, which is obtained by the user equipment by performing uplink power control, of the PUCCH of the another cell which processes carrier aggregation with the cell in the adjacent subframe; P_{CMAX}(i) represents maximum allowable power of the current subframe; and P_{PUSCH,j}(i) represents second transmission power, which is obtained by the user equipment by performing uplink power control, of a PUSCH bearing uplink control signaling in the current subframe.

6. The method according to claim 1, wherein the overlap determined by the user equipment comprises: the PUSCH of the cell in the current subframe, or a PUCCH of the cell in the current subframe, or at least one of the PUSCH and a PUCCH of the cell in the current subframe is overlapped with a PUSCH bearing uplink signaling in the another cell in the adjacent subframe, the another cell being carrier aggregation with the cell.

7. The method according to claim 6, wherein the determining, by the user equipment, according to the determined overlap, the transmission power of the PUSCH of the cell in the current subframe and the another cell in the current subframe, the cell being carrier aggregation with the another cell, comprises:
determining, by the user equipment, according to formula (8), sixth transmission power of the PUSCH of the cell in the current subframe and the another cell which processes carrier aggregation with the cell in the current subframe, wherein:
$${\sum }_{c} w ( i ) \cdot {P}_{PUSCH , c} ( i ) \leq ( {P}_{CMAX} ( i ) - {P}_{PUSCH , k} ( t ) - {P}_{PUCCH} ( i ) ) \qquad ( 8 )$$
wherein w(i) represents a weighting factor, whose value range is [0, 1]; c represents a cell;
$${\sum }_{c} w ( i ) \cdot {P}_{PUSCH , c} ( i )$$
represents the sixth transmission power of the PUSCH of the cell in the current subframe and the another cell which processes carrier aggregation with the cell in the current subframe; P_{PUCCH}(i) represents fourth transmission power, which is obtained by the user equipment by performing uplink power control, of a PUCCH of the cell or the another cell which processes carrier aggregation with the cell in the current subframe; P_{CMAX}(i) represents maximum allowable power of the current subframe; and P_{PUSCH,k}(t) represents first transmission power, which is obtained by the user equipment by performing uplink power control, of a PUSCH bearing uplink control signaling of the cell in the adjacent subframe and the another cell which processes carrier aggregation with the cell in the adjacent subframe; or
determining, by the user equipment, according to formula (9), seventh transmission power of the PUSCH of the cell in the current subframe and the another cell which processes carrier aggregation with the cell in the current subframe, wherein:
$${\sum }_{c} w ( i ) \cdot {P}_{PUSCH , c} ( i ) + u ( i ) \cdot {P}_{PUSCH , k} ( t ) + v ( i ) \cdot {P}_{PUCCH} ( i ) \leq {P}_{CMAX} ( i ) \qquad ( 9 )$$
wherein w(i), u(i), and v(i) represent weighting factors, whose value range is [0, 1]; c represents a cell;
$${\sum }_{c} w ( i ) \cdot {P}_{PUSCH , c} ( i )$$
represents the seventh transmission power of the PUSCH of the cell in the current subframe and the another cell which processes carrier aggregation with the cell in the current subframe; P_{PUCCH}(i) represents fifth transmission power, which is obtained by the user equipment by performing uplink power control, of a PUCCH of the cell or the another cell which processes carrier aggregation with the cell in the current subframe; P_{CMAX}(i) represents maximum allowable power of the current subframe; and P_{PUSCH,k}(t) represents second transmission power, which is obtained by the user equipment by performing uplink power control, of a PUSCH bearing uplink signaling of the cell in the adjacent subframe and the another cell which processes carrier aggregation with the cell in the adjacent subframe.

8. The method according to claim 6, wherein the PUSCH of the cell in the current subframe and the another cell which processes carrier aggregation with the cell in the current subframe comprises a PUSCH bearing uplink control signaling; and, the determining, by the user equipment, according to the determined overlap, the transmission power of the PUSCH of the cell in the current subframe and the another cell in the current subframe, the cell being carrier aggregation with the another cell, comprises:
determining, by the user equipment, according to formulas (10) and (11) or according to formulas (10) and (12), eighth transmission power of the PUSCH of the cell in the current subframe and the another cell which processes carrier aggregation with the cell in the current subframe, wherein:
$$\begin{matrix}{\sum }_{c \neq j} w ( i ) \cdot {P}_{PUSCH , c} ( i ) \leq ( {P}_{CMAX} ( i ) - {P}_{PUSCH , j} ( i ) - {P}_{PUSCH , k} ( t ) ) & ( 10 ) \\ {P}_{PUSCH , j} ( i ) = min \{ {P}_{PUSCH , j\_o} ( i ) , ( {P}_{CMAX} ( i ) - {P}_{PUSCH , k\_o} ( i - 1 ) ) \} & ( 11 ) \\ {P}_{PUSCH , j} ( i ) = min \{ {P}_{PUSCH , j\_o} ( i ) , ( {P}_{CMAX} ( i ) - {P}_{PUSCH , k\_o} ( i + 1 ) ) \} & ( 12 )\end{matrix}$$
wherein w(i) represents a weighting factor, whose value range is [0, 1]; c represents a cell;
$${\sum }_{c \neq j} w ( i ) \cdot {P}_{PUSCH , c} ( i )$$
represents eighth transmission power of a PUSCH bearing no uplink control signaling of the cell in the current subframe and the another cell which processes carrier aggregation with the cell in the current subframe; P_{CMAX}(i) represents maximum allowable power of the current subframe; P_{PUSCH,k}(t) represents third transmission power, which is obtained by the user equipment by performing uplink power control, of a PUSCH bearing uplink signaling of the cell in the adjacent subframe and the another cell which processes carrier aggregation with the cell in the adjacent subframe; P_{PUSCH,j}_{_{—}}ₒ(i) represents third transmission power, which is obtained by the user equipment by performing uplink power control, of a PUSCH bearing uplink signaling comprised in the current frame; P_{PUSCH,k}_{_{—}}ₒ(i−1) represents first transmission power of a PUSCH bearing uplink signaling of the another cell which processes carrier aggregation with the cell in an adjacent subframe before the current subframe; P_{PUSCH,k}_{_{—}}ₒ(i+1) represents first transmission power of a PUSCH bearing uplink signaling of the another cell which processes carrier aggregation with the cell in an adjacent subframe after the current subframe; or
determining, by the user equipment, according to formula (13), ninth transmission power of the PUSCH of the cell in the current subframe and the another cell which processes carrier aggregation with the cell in the current subframe, wherein:
$${\sum }_{c \neq j} w ( i ) \cdot {P}_{PUSCH , c} ( i ) + u ( i ) \cdot {P}_{PUSCH , j} ( i ) + v ( i ) \cdot {P}_{PUSCH , k} ( t ) \leq {P}_{CMAX} ( i ) \qquad ( 13 )$$
wherein w(i)_{, u(i), and v(i) represent weighting factors, whose value range is [}0, 1]; c represents a cell;
$${\sum }_{c \neq j} w ( i ) \cdot {P}_{PUSCH , c} ( i )$$
represents ninth transmission power of a PUSCH bearing no uplink control signaling of the cell in the current subframe and the another cell which processes carrier aggregation with the cell in the current subframe; P_{CMAX}(i) represents maximum allowable power of the current subframe; P_{PUSCH,k}(t) represents the fourth transmission power, which is obtained by the user equipment by performing uplink power control, of a PUSCH bearing uplink signaling of the cell in the adjacent subframe and the another cell which processes carrier aggregation with the cell in the adjacent subframe; P_{PUSCH,j}(i) represents third transmission power, which is obtained by the user equipment by performing uplink power control, of a PUSCH bearing uplink control signaling in the current subframe.

9. The method according to claim 6, wherein the PUSCH of the cell in the current subframe and the another cell which processes carrier aggregation with the cell in the current subframe comprises a PUSCH bearing uplink signaling; the determining, by the user equipment, according to the determined overlap, the transmission power of the PUSCH of the cell in the current subframe and the another cell in the current subframe, the cell being carrier aggregation with the another cell, comprises:
determining, by the user equipment, according to formulas (14) and (15) or according to formulas (14) and (16), tenth transmission power of the PUSCH of the cell in the current subframe and the another cell which processes carrier aggregation with the cell in the current subframe, wherein:
$$\begin{matrix}{\sum }_{c \neq j} w ( i ) \cdot {P}_{PUSCH , c} ( i ) \leq ( {P}_{CMAX} ( i ) - {P}_{PUSCH , j} ( i ) - {P}_{PUSCH , k} ( t ) - {P}_{PUCCH} ( i ) ) & ( 14 ) \\ {P}_{PUSCH , j} ( i ) = min \{ {P}_{PUSCH , j\_o} ( i ) , ( {P}_{CMAX} ( i ) - {P}_{PUCCH} ( i ) - {P}_{PUSCH , k\_o} ( i - 1 ) ) \} & ( 15 ) \\ {P}_{PUSCH , j} ( i ) = min \{ {P}_{PUSCH , j\_o} ( i ) , ( {P}_{CMAX} ( i ) - {P}_{PUCCH} ( i ) - {P}_{PUSCH , k\_o} ( i + 1 ) ) \} & ( 16 )\end{matrix}$$
wherein w(i) represents a weighting factor, whose value range is [0, 1]; c represents a cell;
$${\sum }_{c \neq j} w ( i ) \cdot {P}_{PUSCH , c} ( i )$$
represents the tenth transmission power of a PUSCH bearing no uplink control signaling of the cell in the current subframe and the another cell which processes carrier aggregation with the cell in the current subframe; P_{PUCCH}(i) represents sixth transmission power, which is obtained by the user equipment by performing uplink power control, of the PUCCH of the cell or the another cell which processes carrier aggregation with the cell in the current subframe; P_{CMAX}(i) represents maximum allowable power of the current subframe; P_{PUSCH,k}(t) represents fifth transmission power, which is obtained by the user equipment by performing uplink power control, of a PUSCH bearing uplink signaling of the cell in the adjacent subframe and the another cell which processes carrier aggregation with the cell in the adjacent subframe; P_{PUSCH,j}_{_{—}}ₒ(i) represents fourth transmission power, which is obtained by the user equipment by performing uplink power control, of the PUSCH bearing uplink signaling comprised in the current frame; P_{PUSCH,k}_{_{—}}ₒ(i−1) represents second transmission power of a PUSCH bearing uplink signaling of the another cell which processes carrier aggregation with the cell in an adjacent subframe before the current subframe; P_{PUSCH,k}_{_{—}}ₒ(i+1) represents second transmission power of a PUSCH bearing uplink signaling of the another cell which processes carrier aggregation with the cell in an adjacent subframe after the current subframe; or
determining, by the user equipment, according to formula (17), eleventh transmission power of the PUSCH of the cell in the current subframe and the another cell which processes carrier aggregation with the cell in the current subframe, wherein:
$${\sum }_{c \neq j} w ( i ) \cdot {P}_{PUSCH , c} ( i ) + u ( i ) \cdot {P}_{PUSCH , j} ( i ) + v ( i ) \cdot {P}_{PUSCH , k} ( t ) \leq {P}_{CMAX} ( i ) - {P}_{PUCCH} ( i ) \qquad ( 17 )$$
wherein w(i), u(i), and v(i) represent weighting factors, whose value range is [0, 1]; c represents a cell;
$${\sum }_{c \neq j} w ( i ) \cdot {P}_{PUSCH , c} ( i )$$
represents eleventh transmission power of a PUSCH bearing no uplink control signaling of the cell in the current subframe and the another cell which processes carrier aggregation with the cell in the current subframe; P_{PUCCH}(i) represents seventh transmission power, which is obtained by the user equipment by performing uplink power control, of the PUCCH of the cell or the another cell which processes carrier aggregation with the cell in the current subframe; P_{CMAX}(i) represents maximum allowable power of the current subframe; P_{PUSCH,j}(i) represents fourth transmission power, which is obtained by the user equipment by performing uplink power control, of the PUSCH bearing uplink control signaling in the current subframe; P_{PUSCH,k}(t) represents sixth transmission power, which is obtained by the user equipment by performing uplink power control, of a PUSCH bearing uplink signaling of the cell in the adjacent subframe and the another cell which processes carrier aggregation with the cell in the adjacent subframe.

10. A user equipment, comprising:
an overlap determining unit, configured to determine an overlap between an uplink channel of a cell in a current subframe and an uplink channel of another cell in an adjacent subframe, the cell being carrier aggregation with the another cell; and
a power determining unit, configured to determine, according to the overlap determined by the overlap determining unit, transmission power of a physical uplink shared channel (PUSCH) of the cell in the current subframe and the another cell in the current subframe, the cell being carrier aggregation with the another cell.

11. The user equipment according to claim 10, wherein: the overlap determined by the overlap determining unit comprises: the PUSCH of the cell in the current subframe is overlapped with a physical uplink control channel (PUCCH) of the another cell in the adjacent subframe, the another cell being carrier aggregation with the cell.

12. The user equipment according to claim 11, wherein the power determining unit is specifically configured to:
according to formula (1), determine first transmission power of the PUSCH of the cell in the current subframe and the another cell which processes carrier aggregation with the cell in the current subframe, wherein:
$${\sum }_{c} w ( i ) \cdot {P}_{PUSCH , c} ( i ) \leq ( {P}_{CMAX} ( i ) - max ( {P}_{PUCCH} ( i ) , {P}_{PUCCH} ( t ) ) ) \qquad ( 1 )$$
wherein w(i) represents a weighting factor, whose value range is [0, 1]; c represents a cell;
$${\sum }_{c \neq j} w ( i ) \cdot {P}_{PUSCH , c} ( i )$$
represents the first transmission power of the PUSCH of the cell in the current subframe and the another cell which processes carrier aggregation with the cell in the current subframe; P_{PUCCH}(i) represents first transmission power, which is obtained by the user equipment by performing uplink power control, of a PUCCH of the another cell which processes carrier aggregation with the cell in the current subframe; P_{PUCCH}(t) represents first transmission power, which is obtained by the user equipment by performing uplink power control, of the PUCCH of the another cell which processes carrier aggregation with the cell in the adjacent subframe; and P_{CMAX}(i) represents maximum allowable power of the current subframe.

13. The user equipment according to claim 11, wherein: the PUSCH of the cell in the current subframe and the another cell which processes carrier aggregation with the cell in the current subframe comprises a PUSCH bearing uplink control signaling; and, the power determining unit is specifically configured to:
according to formula (2) and (3), determine second transmission power of the PUSCH of the cell in the current subframe and the another cell which processes carrier aggregation with the cell in the current subframe, wherein:
$$\begin{matrix}{\sum }_{c \neq j} w ( i ) \cdot {P}_{PUSCH , c} ( i ) \leq ( {P}_{CMAX} ( i ) - {P}_{PUSCH , j} ( i ) - {P}_{PUCCH} ( t ) ) & ( 2 ) \\ {P}_{PUSCH , j} ( i ) = min \{ {P}_{PUSCH , j\_o} ( i ) , ( {P}_{CMAX} ( i ) - {P}_{PUCCH} ( t ) ) \} & ( 3 )\end{matrix}$$
wherein w(i) represents a weighting factor, whose value range is [0, 1]; c represents a cell;
$${\sum }_{c \neq j} w ( i ) \cdot {P}_{PUSCH , c} ( i )$$
represents second transmission power of a PUSCH bearing no uplink control signaling of the cell in the current subframe and the another cell which processes carrier aggregation with the cell in the current subframe; P_{PUCCH}(t) represents second transmission power, which is obtained by the user equipment by performing uplink power control, of the PUCCH of the another cell which processes carrier aggregation with the cell in the adjacent subframe; P_{CMAX}(i) represents maximum allowable power of the current subframe; P_{PUSCH,j}_{_{—}}ₒ(i) represents first transmission power, which is obtained by the user equipment by performing uplink power control, of a PUSCH bearing uplink signaling in the current frame; or
according to formula (4), determine third transmission power of the PUSCH of the cell in the current subframe and the another cell which processes carrier aggregation with the cell in the current subframe, wherein:
$${\sum }_{c \neq j} w ( i ) \cdot {P}_{PUSCH , c} ( i ) + u ( i ) \cdot {P}_{PUSCH , j} ( i ) \leq ( {P}_{CMAX} ( i ) - {P}_{PUCCH} ( t ) ) \qquad ( 4 )$$
wherein w(i) and u(i) represent weighting factors, whose value range is [0, 1]; c
$${\sum }_{c \neq j} w ( i ) \cdot {P}_{PUSCH , c} ( i )$$
represents a cell; represents third transmission power of a PUSCH bearing no uplink control signaling of the cell in the current subframe and the another cell which processes carrier aggregation with the cell in the current subframe; P_{PUCCH}(t) represents third transmission power, which is obtained by the user equipment by performing uplink power control, of the PUCCH of the another cell which processes carrier aggregation with the cell in the adjacent subframe; P_{CMAX}(i) represents maximum allowable power of the current subframe; and P_{PUSCH,j}(i) represents first transmission power, which is obtained by the user equipment by performing uplink power control, of a PUSCH bearing uplink control signaling in the current subframe.

14. The user equipment according to claim 11, wherein: the PUSCH of the cell in the current subframe and the another cell which processes carrier aggregation with the cell in the current subframe comprises a PUSCH bearing uplink control signaling; and the power determining unit is specifically configured to:
according to formula (5) and (6), determine fourth transmission power of the PUSCH of the cell in the current subframe and the another cell which processes carrier aggregation with the cell in the current subframe, wherein:
$$\begin{matrix}{\sum }_{c \neq j} w ( i ) \cdot {P}_{PUSCH , c} ( i ) \leq ( {P}_{CMAX} ( i ) - {P}_{PUSCH , j} ( i ) - max ( {P}_{PUCCH} ( i ) , {P}_{PUCCH} ( t ) ) ) & ( 5 ) \\ {P}_{PUSCH , j} ( i ) = min \{ {P}_{PUSCH , j\_o} ( i ) , ( {P}_{CMAX} ( i ) - max ( {P}_{PUCCH} ( i ) , {P}_{PUCCH} ( t ) ) ) \} & ( 6 )\end{matrix}$$
wherein w(i) represents a weighting factor, whose value range is [0, 1]; c represents a cell;
$${\sum }_{c \neq j} w ( i ) \cdot {P}_{PUSCH , c} ( i )$$
represents fourth transmission power of a PUSCH bearing no uplink control signaling of the cell in the current subframe and the another cell which processes carrier aggregation with the cell in the current subframe; P_{PUCCH}(i) represents second transmission power, which is obtained by the user equipment by performing uplink power control, of the PUCCH of the another cell which processes carrier aggregation with the cell in the current subframe; P_{PUCCH}(t) represents fourth transmission power, which is obtained by the user equipment by performing uplink power control, of the PUCCH of the another cell which processes carrier aggregation with the cell in the adjacent subframe; P_{CMAX}(i) represents maximum allowable power of the current subframe; P_{PUSCH,j}_{_{—}}ₒ(i) represents second transmission power, which is obtained by the user equipment by performing uplink power control, of a PUSCH bearing uplink signaling comprised in the current frame; or
according to formula (7), determine fifth transmission power of the PUSCH of the cell in the current subframe and the another cell which processes carrier aggregation with the cell in the current subframe, wherein:
$${\sum }_{c \neq j} w ( i ) \cdot {P}_{PUSCH , c} ( i ) + u ( i ) \cdot {P}_{PUSCH , j} ( i ) \leq ( {P}_{CMAX} ( i ) - max ( {P}_{PUCCH} ( i ) , {P}_{PUCCH} ( t ) ) ) \qquad ( 7 )$$
wherein w(i) and u(i) represent weighting factors, whose value range is [0, 1]; c represents a cell;
$${\sum }_{c \neq j} w ( i ) \cdot {P}_{PUSCH , c} ( i )$$
represents fifth transmission power of a PUSCH bearing no uplink control signaling of the cell in the current subframe and the another cell which processes carrier aggregation with the cell in the current subframe; P_{PUCCH}(i) represents third transmission power, which is obtained by the user equipment by performing uplink power control, of the PUCCH of the another cell which processes carrier aggregation with the cell in the current subframe; P_{PUCCH}(t) represents fifth transmission power, which is obtained by the user equipment by performing uplink power control, of the PUCCH of the another cell which processes carrier aggregation with the cell in the adjacent subframe; P_{CMAX}(i) represents maximum allowable power of the current subframe; and P_{PUSCH,j}(i) represents second transmission power, which is obtained by the user equipment by performing uplink power control, of a PUSCH bearing uplink control signaling in the current subframe.

15. The user equipment according to claim 10, wherein the overlap determined by the overlap determining unit comprises: the PUSCH of the cell in the current subframe, or a PUCCH of the cell in the current subframe, or at least one of a PUSCH and the PUCCH of the cell in the current subframe is overlapped with a PUSCH bearing uplink signaling in the another cell in the adjacent subframe, the another cell being carrier aggregation with the cell.

16. The user equipment according to claim 15, wherein the power determining unit is specifically configured to:
according to formula (8), determine sixth transmission power of the PUSCH of the cell in the current subframe and the another cell which processes carrier aggregation with the cell in the current subframe, wherein:
$${\sum }_{c} w ( i ) \cdot {P}_{PUSCH , c} ( i ) \leq ( {P}_{CMAX} ( i ) - {P}_{PUSCH , k} ( t ) - {P}_{PUCCH} ( i ) ) \qquad ( 8 )$$
wherein w(i) represents a weighting factor, whose value range is [0, 1]; c represents a cell;
$${\sum }_{c} w ( i ) \cdot {P}_{PUSCH , c} ( i )$$
represents the sixth transmission power of the PUSCH of the cell in the current subframe and the another cell which processes carrier aggregation with the cell in the current subframe; P_{PUCCH}(i) represents fourth transmission power, which is obtained by the user equipment by performing uplink power control, of a PUCCH of the cell or the another cell which processes carrier aggregation with the cell in the current subframe; P_{CMAX}(i) represents maximum allowable power of the current subframe; P_{PUSCH,k}(t) represents first transmission power, which is obtained by the user equipment by performing uplink power control, of a PUSCH bearing uplink control signaling of the cell in the adjacent subframe and the another cell which processes carrier aggregation with the cell in the adjacent subframe; or
according to formula (9), determine seventh transmission power of the PUSCH of the cell in the current subframe and the another cell which processes carrier aggregation with the cell in the current subframe, wherein:
$${\sum }_{c} w ( i ) \cdot {P}_{PUSCH , c} ( i ) + u ( i ) \cdot {P}_{PUSCH , k} ( t ) + v ( i ) \cdot {P}_{PUCCH} ( i ) \leq {P}_{CMAX} ( i ) \qquad ( 9 )$$
wherein w(i), u(i), and v(i) and represent weighting factors, whose value range is [0, 1]; c represents a cell;
$${\sum }_{c} w ( i ) \cdot {P}_{PUSCH , c} ( i )$$
represents seventh transmission power of the PUSCH of the cell in the current subframe and the another cell which processes carrier aggregation with the cell in the current subframe; P_{PUCCH}(i) represents fifth transmission power, which is obtained by the user equipment by performing uplink power control, of a PUCCH of the cell or the another cell which processes carrier aggregation with the cell in the current subframe; P_{CMAX}(i) represents maximum allowable power of the current subframe; and P_{PUSCH,k}(t) represents second transmission power, which is obtained by the user equipment by performing uplink power control, of a PUSCH bearing uplink signaling of the cell in the adjacent subframe and the another cell which processes carrier aggregation with the cell in the adjacent subframe.

17. The user equipment according to claim 15, wherein the PUSCH of the cell in the current subframe and the another cell which processes carrier aggregation with the cell in the current subframe comprises a PUSCH bearing uplink control signaling; and, the power determining unit is specifically configured to:
according to formulas (10) and (11) or according to formulas (10) and (12), determine eighth transmission power of the PUSCH of the cell in the current subframe and the another cell which processes carrier aggregation with the cell in the current subframe, wherein:
$$\begin{matrix}{\sum }_{c \neq j} w ( i ) \cdot {P}_{PUSCH , c} ( i ) \leq ( {P}_{CMAX} ( i ) - {P}_{PUSCH , j} ( i ) - {P}_{PUSCH , k} ( t ) ) & ( 10 ) \\ {P}_{PUSCH , j} ( i ) = min \{ {P}_{PUSCH , j\_o} ( i ) , ( {P}_{CMAX} ( i ) - {P}_{PUSCH , k\_o} ( i - 1 ) ) \} & ( 11 ) \\ {P}_{PUSCH , j} ( i ) = min \{ {P}_{PUSCH , j\_o} ( i ) , ( {P}_{CMAX} ( i ) - {P}_{PUSCH , k\_o} ( i + 1 ) ) \} & ( 12 )\end{matrix}$$
wherein w(i) represents a weighting factor, whose value range is [0, 1]; c represents a cell;
$${\sum }_{c \neq j} w ( i ) \cdot {P}_{PUSCH , c} ( i )$$
represents eighth transmission power of a PUSCH bearing no uplink control signaling of the cell in the current subframe and the another cell which processes carrier aggregation with the cell in the current subframe; P_{CMAX}(i) represents maximum allowable power of the current subframe; P_{PUSCH,k}(t) represents third transmission power, which is obtained by the user equipment by performing uplink power control, of a PUSCH bearing uplink signaling of the cell in the adjacent subframe and the another cell which processes carrier aggregation with the cell in the adjacent subframe; P_{PUSCH,j}_{_{—}}ₒ(i) represents third transmission power, which is obtained by the user equipment by performing uplink power control, of a PUSCH bearing uplink signaling comprised in the current frame; P_{PUSCH,k}_{_{—}}ₒ(i−1) represents first transmission power of a PUSCH bearing uplink signaling of the another cell which processes carrier aggregation with the cell in an adjacent subframe before the current subframe; and P_{PUSCH,k}_{_{—}}ₒ(i+1) represents first transmission power of a PUSCH bearing uplink signaling of the another cell which processes carrier aggregation with the cell in an adjacent subframe after the current subframe; or
according to formula (13), determine ninth transmission power of the PUSCH of the cell in the current subframe and the another cell which processes carrier aggregation with the cell in the current subframe, wherein:
$${\sum }_{c \neq j} w ( i ) \cdot {P}_{PUSCH , c} ( i ) + u ( i ) \cdot {P}_{PUSCH , j} ( i ) + v ( i ) \cdot {P}_{PUSCH , k} ( t ) \leq {P}_{CMAX} ( i ) \qquad ( 13 )$$
wherein w(i), u(i), and v(i) represent weighting factors, whose value range is [0, 1]; c represents a cell;
$${\sum }_{c \neq j} w ( i ) \cdot {P}_{PUSCH , c} ( i )$$
represents ninth transmission power of a PUSCH bearing no uplink control signaling of the cell in the current subframe and the another cell which processes carrier aggregation with the cell in the current subframe; P_{CMAX}(i) represents maximum allowable power of the current subframe; P_{PUSCH,k}(t) represents the fourth transmission power, which is obtained by the user equipment by performing uplink power control, of a PUSCH bearing uplink signaling of the cell in the adjacent subframe and the another cell which processes carrier aggregation with the cell in the adjacent subframe; and P_{PUSCH,j}(i) represents third transmission power, which is obtained by the user equipment by performing uplink power control, of a PUSCH bearing uplink control signaling in the current subframe.

18. The user equipment according to claim 15, wherein: the PUSCH of the cell in the current subframe and the another cell which processes carrier aggregation with the cell in the current subframe comprises a PUSCH bearing uplink signaling; and the power determining unit is specifically configured to:
according to formulas (14) and (15) or according to formulas (14) and (16), determine tenth transmission power of the PUSCH of the cell in the current subframe and the another cell which processes carrier aggregation with the cell in the current subframe, wherein:
$$\begin{matrix}{\sum }_{c \neq j} w ( i ) \cdot {P}_{PUSCH , c} ( i ) \leq ( {P}_{CMAX} ( i ) - {P}_{PUSCH , j} ( i ) - {P}_{PUSCH , k} ( t ) - {P}_{PUCCH} ( i ) ) & ( 14 ) \\ {P}_{PUSCH , j} ( i ) = min \{ {P}_{PUSCH , j\_o} ( i ) , ( {P}_{CMAX} ( i ) - {P}_{PUCCH} ( i ) - {P}_{PUSCH , k\_o} ( i - 1 ) ) \} & ( 15 ) \\ {P}_{PUSCH , j} ( i ) = min \{ {P}_{PUSCH , j\_o} ( i ) , ( {P}_{CMAX} ( i ) - {P}_{PUCCH} ( i ) - {P}_{PUSCH , k\_o} ( i + 1 ) ) \} & ( 16 )\end{matrix}$$
wherein w(i) represents a weighting factor, whose value range is [0, 1]; c represents a cell;
$${\sum }_{c \neq j} w ( i ) \cdot {P}_{PUSCH , c} ( i )$$
represents the tenth transmission power of a PUSCH bearing no uplink control signaling of the cell in the current subframe and the another cell which processes carrier aggregation with the cell in the current subframe; P_{PUCCH}(i) represents sixth transmission power, which is obtained by the user equipment by performing uplink power control, of the PUCCH of the cell or the another cell which processes carrier aggregation with the cell in the current subframe; P_{CMAX}(i) represents maximum allowable power of the current subframe; P_{PUSCH,k}(t) represents fifth transmission power, which is obtained by the user equipment by performing uplink power control, of a PUSCH bearing uplink signaling of the cell in the adjacent subframe and the another cell which processes carrier aggregation with the cell in the adjacent subframe; P_{PUSCH,j}_{_{—}}ₒ(i) represents fourth transmission power, which is obtained by the user equipment by performing uplink power control, of the PUSCH bearing uplink signaling in the current frame; P_{PUSCH,k}_{_{—}}ₒ(i−1) represents second transmission power of a PUSCH bearing uplink signaling of the another cell which processes carrier aggregation with the cell in an adjacent subframe before the current subframe; P_{PUSCH,k}_{_{—}}ₒ(i+1) represents second transmission power of a PUSCH bearing uplink signaling of the another cell which processes carrier aggregation with the cell in an adjacent subframe after the current subframe; or
according to formula (17), determine eleventh transmission power of the PUSCH of the cell in the current subframe and the another cell which processes carrier aggregation with the cell in the current subframe, wherein:
$${\sum }_{c \neq j} w ( i ) \cdot {P}_{PUSCH , c} ( i ) + u ( i ) \cdot {P}_{PUSCH , j} ( i ) + v ( i ) \cdot {P}_{PUSCH , k} ( t ) \leq {P}_{CMAX} ( i ) - {P}_{PUCCH} ( i ) \qquad ( 13 )$$
wherein w(i), u(i), and v(i) represent weighting factors, whose value range is [0, 1]; c represents a cell;
$${\sum }_{c \neq j} w ( i ) \cdot {P}_{PUSCH , c} ( i )$$
represents eleventh transmission power of a PUSCH bearing no uplink control signaling of the cell in the current subframe and the another cell which processes carrier aggregation with the cell in the current subframe; P_{PUCCH}(i) represents seventh transmission power, which is obtained by the user equipment by performing uplink power control, of the PUCCH of the cell or the another cell which processes carrier aggregation with the cell in the current subframe; P_{CMAX}(i) represents maximum allowable power of the current subframe; P_{PUSCH,j}(i) represents fourth transmission power, which is obtained by the user equipment by performing uplink power control, of the PUSCH bearing uplink control signaling in the current subframe; P_{PUSCH,k}(t) represents sixth transmission power, which is obtained by the user equipment by performing uplink power control, of a PUSCH bearing uplink signaling of the cell in the adjacent subframe and the another cell which processes carrier aggregation with the cell in the adjacent subframe.
